(19) United States
(12) Patent Application Publication
(10) Pub. No.: US 2012/0253767 A1
(43) Pub. Date: Oct. 4, 2012

(54) Simulating a Droplet with Moving Contact Edge

(76) Inventors: Sangpil Yoon, Campbell, CA (US); Jiun-Der Yu, Sunnyvale, CA (US)

(21) Appl. No.: 13/075,730

(22) Filed: Mar. 30, 2011

(51) Int. Cl. G06G 7/48

(52) U.S. Cl. 703/9

(57) ABSTRACT

Systems and methods for simulating a droplet with a moving contact line are presented. In embodiments, a height profile of the droplet on a substrate may be simulated using a lubrication equation solution that includes an artificial fluid flux to account for fluid loss due to the contact line movement. Embodiments may include a solute convection/diffusion equation with slipping contact dynamics solution to simulate the shape of the solute deposit on a substrate. When the contact line moves, the convection-diffusion equation includes an artificial solute flux to conserve mass. In embodiments, the droplet may be modeled as being on a planar or on a non-planar surface.

### CROSS-REFERENCE TO RELATED APPLICATION(S)

The present application is related to commonly assigned and co-pending U.S. patent application Ser. No. ______ filed on Mar. 30, 2011, entitled “SIMULATING A DROPLET WITH MOVING CONTACT EDGE ON A PLANAR SURFACE” (Attorney Docket No. AP483HO) and is hereby incorporated by reference in its entirety.

### BACKGROUND

1. Field of Invention

The present application is directed towards systems and methods for simulating evaporation of a droplet with a moving contact edge.

2. Description of the Related Art

Applying inkjet technology to the industrial processes can greatly improve their efficiencies. Inkjet technology can be used to save energy, material, money, and it can also help improve the environment. Inkjet technology may be used in the manufacture of liquid crystal displays (LCD), thin film transistors (TFT), organic light emitting diodes (OLED), solar cells, micro-circuits, and other planar, layered, or 3-D structures. In the inkjet printing process, small droplets of a solution containing a solute with the desired properties and a solvent to make the solution jettable are deposited onto the target area. After the droplets reach the targeted area, some or all of the solvent evaporates and the solute is left to form a final print pattern. The final pattern of the deposited solute can directly determine the quality of the desired product.

In order to improve the quality of the final product, it is desirable to understand how the final pattern is formed in a realistic environment, what are the major factors affecting the final pattern, and how to control the production parameters in order to achieve a final product with the desired quality. In the final stage of ink drying process, the aspect ratio of length to height becomes quite large. Consequently, it is difficult to use traditional direct simulation methods to simulate the entire process. Lubrication equations may be applied to describe such phenomenon; however in the prior art lubrication type equations have been limited to periodic thin films, infinite thin films or films with fixed contact lines. This is because a moving contact used along with lubrication type equations produces a singularity at the contact line.

What has not been developed are systems and methods for modeling and predicating the evaporation of a droplet with a moving contact line. The present invention is directed towards addressing these problems.

### SUMMARY OF INVENTION

The present invention comprises systems and methods for simulating a droplet on a substrate with a moving contact line. Embodiments of the present invention include methods that have been encoded upon one or more computer-readable media with instructions for one or more processors or processing units to perform. The method may include a plurality of instructions that are executed by the processor.

In embodiments, methods for simulating droplet height changes due to evaporation may comprise discretizing a lubrication equation to obtain height values. In embodiments, a mesh for a domain of at least a portion of a droplet with a contact edge is generated. The mesh comprising a plurality of cells or elements. In embodiments, the end cell has an outer edge that is correlated with the contact edge of the droplet. The contact edge velocity of the contact edge of the droplet is determined. Based upon the contact edge velocity, the contact edge of the droplet is adjusted accordingly.

If the contact edge has moved more than a threshold amount, the domain of the at least a portion of the droplet is remeshed. In embodiments, remeshing comprises generating a new mesh for the domain and interpolating droplet height values for the new mesh. In embodiments, the cells of the mesh and the new mesh are initially uniform in size.

If the contact edge has not moved more than a threshold amount, a smooth profile for the contact edge velocity is obtained and the lubrication equation is solved to obtain droplet height values. In embodiments, solving the lubrication equation includes the addition of an artificial fluid flux to compensate for loss due to the adjusting of the contact edge of the droplet, thereby conserving droplet mass.

In embodiment, the above-stated processes may be iterated until a stop condition has been reached.

In embodiments, the contact edge velocity may be determined using an angle between the contact edge of the droplet and the surface on which the droplet rests. In embodiments, the angle and Hoffman's model may be used to determine the contact edge velocity. One skilled in the art shall recognize that other models for obtaining contact edge velocity may be employed.

In embodiments, the above-methodologies may be extended to include solving a solute convection/diffusion equation with slipping contact dynamics to simulate the shape of the solute deposit on a substrate. In embodiments, height values from the lubrication equation solution may be used in solving a convection-diffusion equation to obtain solute concentration values in the droplet, the convection-diffusion equation including an artificial solute flux to compensate for the adjusting of the contact edge of the droplet. In embodiments, when remeshing, the solute concentration values may also be interpolated for the new mesh cells.

In embodiments, the droplet may be modeled as being on a planar surface.

Alternatively, in embodiments, the droplet may be modeled as being on a non-planar surface. Thus, the fourth-order lubrication equation and the second-order solute convection/diffusion equation may be derived so that both the slipping contact line dynamics and the substrate geometry are considered.

In embodiments of the present invention, a fluid may be prepared in response to the results of a simulation.

Some features and advantages of the invention have been generally described in this summary section; however, additional features, advantages, and embodiments are presented herein or will be apparent to one of ordinary skill in the art in view of the drawings, specification, and claims hereof. Accordingly, it should be understood that the scope of the invention shall not be limited by the particular embodiments disclosed in this summary section.

### BRIEF DESCRIPTION OF THE DRAWINGS

Reference will be made to embodiments of the invention, examples of which may be illustrated in the accompanying figures, in which like parts may be referred to by like or similar numerals. These figures are intended to be illustrative, not limiting. Although the invention is generally described in the context of these embodiments, it should be understood that it is not intended to limit the scope of the invention to these particular embodiments.

FIG. 1A illustrates simulation of an evaporating droplet with a moving contact line according to axisymmetric embodiments of the present invention.

FIG. 1B illustrates simulation of an evaporating droplet with a moving contact line according to two-dimensional embodiments of the present invention.

FIG. 2 illustrates a finite difference grid according to embodiments of the invention.

FIG. 3 illustrates depicts an ALE scheme for a moving contact line for a droplet according to embodiments of the present invention.

FIG. 4 illustrates a special discretization for the last element of the mesh according to embodiments of the present invention

FIG. 5 illustrates a special ALE discretization for the last element of the mesh for the right hand side of Equation 14 according to embodiments of the present invention.

FIG. 6 illustrates the relationship between the critical contact angle, θₛ, and the contact angle, θ, according to embodiments of the present invention.

FIG. 7 illustrates a graph 700 showing a correlation curve for Hoffman's model for a moving contact line.

FIG. 8 illustrates shows two velocity profile 805 and 810 according to embodiments of the present invention.

FIG. 9 illustrates methods for simulating the evaporation of a droplet according to embodiments of the present invention.

FIG. 10 depicts an embodiment of a method for solving the lubrication equation according to embodiments of the present invention.

FIG. 11A illustrates a first example of droplet height simulation according to embodiments of the present invention.

FIG. 11B illustrates a second example of droplet height simulation according to embodiments of the present invention.

FIG. 12 illustrates the mass conservation for a two-dimensional droplet evaporation simulation according to embodiments of the present invention.

FIG. 13 illustrates methods for simulating the solute concentration of evaporating droplet according to embodiments of the present invention.

FIG. 14 illustrates a method of obtaining the solute concentration according to embodiments of the present invention.

FIG. 15A illustrates droplet height, h, at various time increments according to embodiments of the present invention.

FIG. 15B illustrates the droplet concentration, C, at various time increments according to embodiments of the present invention.

FIG. 16 illustrates an embodiment of a special discretization for the last element to handle a special boundary condition, (H−f)=0, for a non-planar substrate according to embodiments of the present invention.

FIG. 17 illustrates an approximation of f_{c}′ according to embodiments of the present invention.

FIG. 18 illustrates a droplet 1805 on a non-planar substrate 1810 according to embodiments of the present invention.

FIG. 19 illustrates a special ALE discretization for the last mesh element for axisymmetric embodiments according to embodiments of the present invention.

FIG. 20 illustrates a droplet 2005 on a non-planar substrate 2010 according to embodiments of the present invention.

FIG. 21 illustrates methods for simulating the height and solute concentration of evaporating droplet on a non-planar surface according to embodiments of the present invention.

FIG. 22 illustrates a method of solving for height and solute concentration for a droplet on a non-planar surface according to embodiments of the present invention.

FIG. 23A illustrates the droplet height results of a numerical simulation of a droplet according to embodiments of the invention.

FIG. 23B illustrates the solute concentration results of a numerical simulation of a droplet according to embodiments of the invention.

FIG. 24 illustrates a computing system or processing system according to embodiments of the invention.

### DESCRIPTION OF THE PREFERRED EMBODIMENTS

In the following description, for purposes of explanation, specific details are set forth in order to provide an understanding of the invention. It will be apparent, however, to one skilled in the art that the invention can be practiced without these details. Furthermore, one skilled in the art will recognize that embodiments of the present invention, described below, may be implemented in a variety of ways, including software, hardware, or firmware, or combinations thereof. Accordingly, the figures described herein are illustrative of specific embodiments of the invention and are meant to avoid obscuring the invention.

Components, or modules, shown in block diagrams are illustrative of exemplary embodiments of the invention and are meant to avoid obscuring the invention. It shall also be understood that throughout this discussion that components may be described as separate functional units, which may comprise sub-units, but those skilled in the art will recognize that various components, or portions thereof, may be divided into separate components or may be integrated together, including integrated within a single system or component. It should be noted that functions or operations discussed herein may be implemented as components or modules.

Furthermore, connections between components within the figures are not intended to be limited to direct connections. Rather, data between these components may be modified, re-formatted, or otherwise changed by intermediary components. Also, additional or fewer connections may be used. It shall also be noted that the terms “coupled” or “communicatively coupled” shall be understood to include direct connections, indirect connections through one or more intermediary devices, and wireless connections.

Reference in the specification to “one embodiment,” “preferred embodiment,” “an embodiment,” or “embodiments” means that a particular feature, structure, characteristic, or function described in connection with the embodiment is included in at least one embodiment of the invention and may be in more than one embodiment. The appearances of the phrases “in one embodiment,” “in an embodiment,” or “in embodiments” in various places in the specification are not necessarily all referring to the same embodiment or embodiments.

The use of certain terms in various places in the specification is for illustration and should not be construed as limiting. Usage of the term “service” or “function” is not limited to describing a single function; usage of the term also may refer to a grouping of related functions or functionality. Similarly, usage of the term “resource” is not limited to describing a single resource; the term also may be used to refer to a set of resources that may either be distributed or aggregated within a computing environment.

The present invention relates to systems and methods for simulating droplet evaporation on a substrate. In embodiments of the present invention, the droplet may be produced using inkjet technology. The present invention may be used to simulate droplet evaporation produced using other techniques without going beyond the spirit and scope of the present invention.

Inkjet technology is conventionally used to print ink on paper. However, a tremendous amount of resources can be saved by applying inkjet technology to other fabrication processes, such as semiconductor fabrication processes, LCD fabrication processes, TFT fabrication processes, OLED fabrication processes, solar cell fabrication processes, etc. In the inkjet printing process, small droplets of a solution deposited onto the target area. The solution is typically formed of a combination of one or more solute materials in solvent formed of one or more materials. The solute material or materials (e.g., metal particles, polymers, or other solids) are dispersed or dissolved in the solvent (water or other liquid) to make the “ink.” The ink is put into an ink jet print head and ink droplets are ejected onto a substrate. The solvent evaporates and a thin film of the solute material is formed on the substrate. The final pattern of the droplet directly determines the desired product quality. An individual skilled in the art will appreciate that aspects of the present invention may be applied to any droplet on a substrate. The targeted area on which the droplet is deposit may be a flat substrate or a non-flat substrate, without going beyond the scope and spirit of the present invention.

Consider, by way of illustration and not limitation, an LCD panel, which is an exemplary product that can be produced using an industrial printing process such as inkjet printing technology. In an embodiment of the present invention, inkjet printing technology is used to fabricate the LCD panel. Traditionally, LCD panels are fabricated using CMOS fabrication technology requiring several processing steps such as masking, deposition, unmasking, etc., to fabricate Red (R), Green (G), and Blue (B) filters on a non-uniform substrate. Each color is made from a different material, and in the traditional fabrication method requires three separate processing steps.

Using inkjet technology, filters made from different materials may all be printed in a single step. Inkjet technology creates images and objects using small droplets of fluid. The inkjet printing head deposits small droplets in a desired pattern on a substrate. Until the droplets dry, the shapes of these droplets may change continuously due to evaporation and other properties of the fluid and substrate. As the droplet dries, the contact line or edge may move, which can have a significant affect on the final shape of the droplet. Therefore, the final pattern of the drops may change into a shape and size that is not desirable. For example, in LCD fabrication, if droplets for red filters and green filters are printed too far away from each other, a lower LCD resolution will result. However, if these droplets are placed too close, the drops may overlap when dried. Therefore, it is important to simulate the final pattern of a drop in order to proceed with confidence that the end product will be acceptable. Simulating the motion of a moving contact line in an evaporating droplet can present significant challenges. It should be noted that this LCD example simply illustrates one of the uses of the present invention in industrial applications.

In embodiments, a lubrication model that accommodates the slipping contact line is presented. Also, in embodiments, the model is extended to solve the solute convection/diffusion equation with slipping contact line.

### I. Governing Equations for Droplet Evaporation Simulation

### A. Governing Equations for Axisymmetric Embodiments

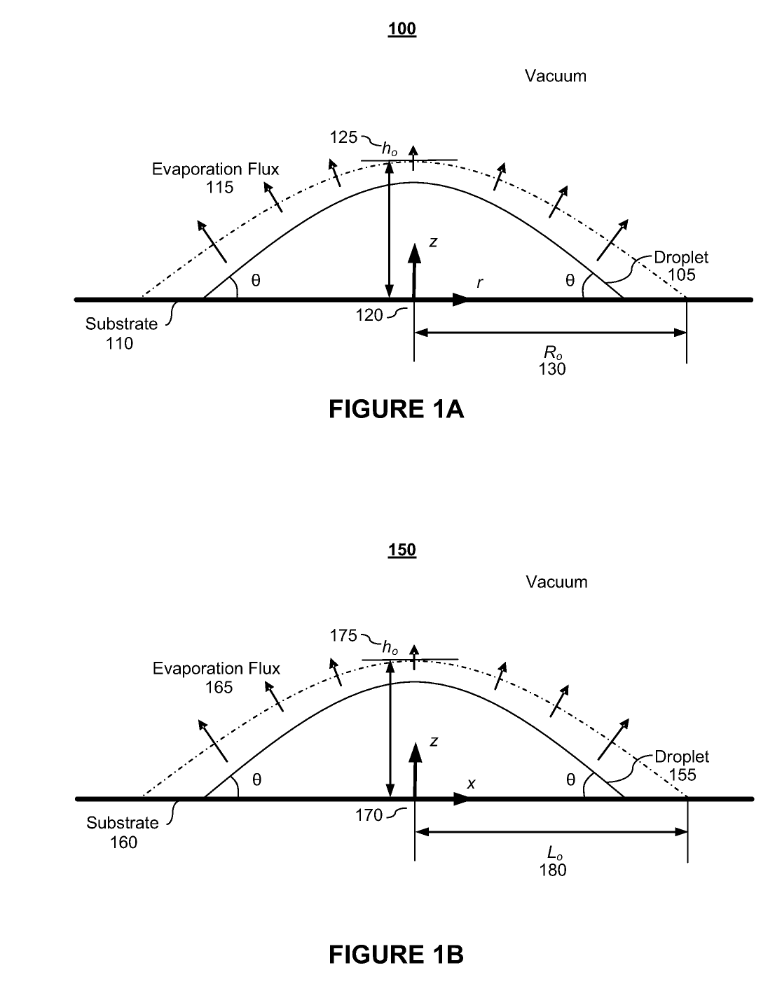

FIG. 1A depicts a simulation 100 of an evaporating droplet 105 with a moving contact line according to embodiments of the present invention. As illustrated in FIG. 1A, a liquid drop 105 is shown on a flat substrate 110. As the liquid evaporates, the size of droplet becomes smaller; that is, the edge of the droplet moves toward the center 120 of the droplet. The basic governing equations to describe the phenomenon can be derived from the general Navier-Stokes equations with no body force. In embodiments, the droplet shape is assumed to be axisymmetric with the axisymmetric coordinate, (r, θ, z), and with the origin located at the center 120 of the bottom circle of the droplet 105 and that the droplet is thin, hₒ<<Rₒ, where hₒ 125 is the initial height and Rₒ 130 is the initial radius of the droplet:

$$\begin{matrix}0 = \frac{{\partial }^{2} u}{\partial {z}^{2}} - \frac{\partial p}{\partial r} & ( 1 ) \\ 0 = \frac{\partial p}{\partial z} & ( 2 ) \\ ( ɛ \frac{1}{r} \frac{\partial ru}{\partial r} + \frac{\partial w}{\partial z} ) = 0 & ( 3 )\end{matrix}$$

Along the interface between the droplet and vacuum, normal stress and tangential stress are balanced and the zero shear stress condition is imposed:

$$\begin{matrix}p = - \frac{1}{{C}_{a}} \frac{1}{r} \frac{\partial }{\partial r} \{ r \frac{\partial h}{\partial r} \} & ( 4 ) \\ \frac{\partial u}{\partial z} = 0 & ( 5 )\end{matrix}$$

In the above, u and w are the fluid velocities, p is the pressure, h is the droplet height, Ca is a capillary number,

$$Ca = \frac{2 {J}_{o} μ}{{ɛ}^{4} σ}$$

$$and$$

$$ɛ = \frac{{h}_{o}}{{R}_{o}}$$

in which σ is surface tension and μ is viscosity of the fluid. In embodiments, all equations are written in dimensionless form by normalization in which r and z is normalized by Rₒ and hₒ, respectively, and the time scale is

$$\frac{{h}_{o}}{2 {J}_{o}}$$

while the pressure scale is

$$\frac{ρ 2 {J}_{o} {R}_{o}}{{h}_{o}^{2}} ,$$

where ρ is the initial fluid density and Jₒ is the evaporation rate that has the same dimension as that of Uₒ.

In embodiments, the boundary condition with the slipping contact line model can be incorporated as Eq. (1) is integrated:

$$u = \frac{\partial p}{\partial r} ( \frac{1}{2} {z}^{2} - hz ) + {U}_{o} \qquad ( 6 )$$

Uₒ(r) is the slipping velocity at z=0. In embodiments, it is such that Uₒ=0 if r<<r_{c} and Uₒ is related to the contact angle θ, and material properties, such as surface tension and viscosity, at r=r_{c}.

Thus the average velocity <u>, which is the average of u over z, is given by:

$$< u >= \frac{1}{h} {\int }_{0}^{h} udz = \frac{1}{h} {\int }_{0}^{h} ( \frac{\partial p}{\partial r} ( \frac{1}{2} {z}^{2} - hz ) + {U}_{o} ) d z = \frac{\partial p}{\partial r} ( - \frac{{h}^{2}}{3} ) + {U}_{o} \\ < u >= \frac{{h}^{2}}{3 {C}_{a}} \frac{\partial }{\partial r} ( \frac{1}{r} \frac{\partial }{\partial r} \{ r \frac{\partial h}{\partial r} \} ) + {U}_{o} \qquad ( 7 )$$

The conservation of mass, together with Eq. (7), gives the lubrication equation with slipping contact line:

$$\begin{matrix}\frac{\partial h}{\partial t} = - \frac{1}{r} \frac{\partial }{\partial r} ( rh < u > ) - J \\ = - \frac{1}{r} \frac{\partial }{\partial r} \{ \frac{{rh}^{3}}{3 {C}_{a}} \frac{\partial }{\partial r} ( \frac{1}{r} \frac{\partial }{\partial r} \{ r \frac{\partial h}{\partial r} \} ) \} - \frac{1}{r} \frac{\partial }{\partial r} ( {rhU}_{o} ) - J\end{matrix} \qquad ( 8 )$$

where J is the evaporating rate. The boundary conditions for Eq. (8) are given by:

$$\begin{matrix}r = 0 \\ \frac{\partial h}{\partial r} = 0 \\ and \\ < u >= 0 & ( 9 ) \\ r = {r}_{c} \\ h = 0 \\ and \\ h < u >= 0 & ( 10 )\end{matrix}$$

### B. Governing Equations for Two-Dimensional (2D) Embodiments

In embodiments, if the droplet shape does not possess a uniaxial symmetry and one dimension of the structure is much longer than the other, it can be modeled that the variation through the longer dimension is small. FIG. 1B depicts a simulation 150 of an evaporating droplet 155 with a moving contact line according to embodiments of the present invention. As illustrated in FIG. 1B, a liquid drop 155 is shown on a flat substrate 610. As the liquid evaporates, the size of droplet becomes smaller; that is, the edges of the droplet moves toward the center 170 of the droplet. In embodiments, the droplet shape is assumed to be have coordinate (x, z) and that the droplet is thin, hₒ<<Lₒ, where hₒ 175 is the initial height and Lₒ 180 is the initial width of the computational domain, which is half the width of the droplet measured from the center. Therefore, the above formulation can be further simplified using two-dimensional coordinate (x, z) settings as follows:

$$\begin{matrix}\frac{\partial h}{\partial t} = - \frac{\partial }{\partial x} ( h < u > ) - J \\ = - \frac{\partial }{\partial x} ( \frac{{h}^{3}}{3 {C}_{a}} \frac{{\partial }^{3} h}{\partial {x}^{3}} ) - \frac{\partial }{\partial x} ( {hU}_{o} ) - J\end{matrix} \qquad ( 11 )$$

In embodiments, the boundary conditions for Eq. (11) are given by:

$$\begin{matrix}\begin{matrix}x = 0 & \frac{\partial h}{\partial x} = 0 and 〈 u 〉 = 0\end{matrix} & ( 12 ) \\ \begin{matrix}x = {x}_{c} & h = 0 and h 〈 u 〉 = 0\end{matrix} & ( 13 )\end{matrix}$$

### C. The Finite Difference Scheme for Axisymmetric Case

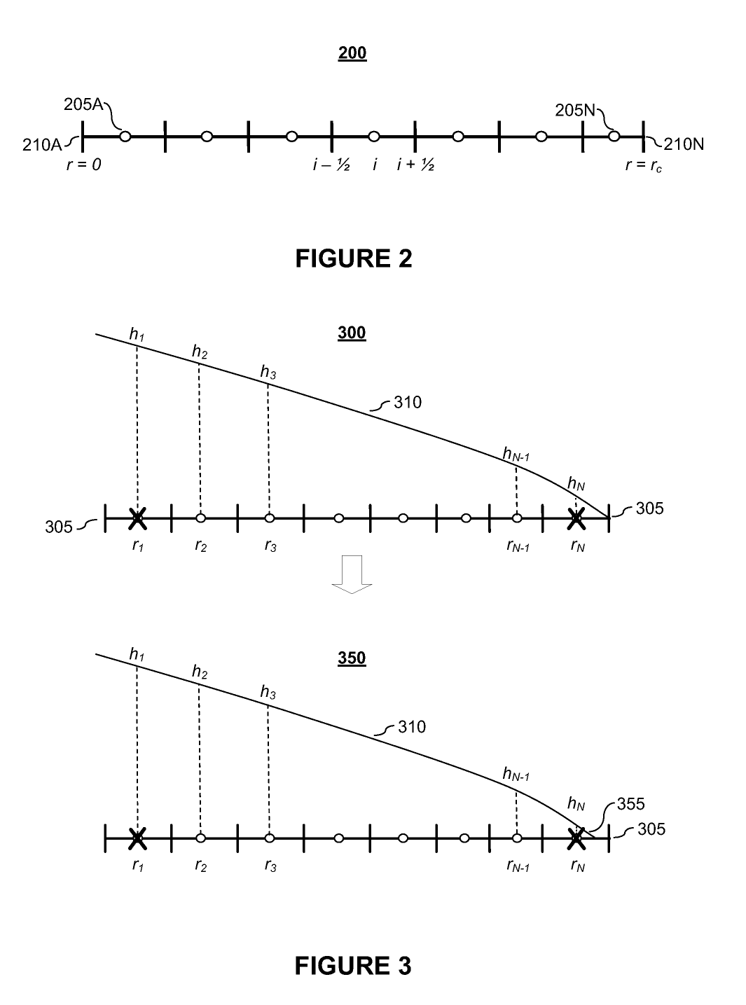

The following describes embodiments of general numerical procedures to solve the droplet evaporation equation, Eq. (8), with slipping contact line using finite difference. As shown in FIG. 2, a finite difference grid 200 can be configured along the computational domain. In embodiments, a uniform grid may be used; however, in alternative embodiments, a non-uniform grid may be used.

In the depicted embodiment of FIG. 2, the black crosses represent cell edges and the circles represent cell centers. In embodiments, the unknown height, h, is defined at cell centers, and the average velocity <u> is defined at cell edges. One skilled in the art will appreciate how to extend the present invention into other coordinate systems, along multiple axes, and higher dimensions without going beyond the scope and spirit of the present invention. In embodiments, the evaporation rate, J, is given. Suppose the solution hⁿ at time t=tⁿ is known, the purpose of the numerical scheme is to find the solution hⁿ⁺¹ at tⁿ⁺¹=tⁿ+Δt, where Δt is the time step or time increment. Thus,

$$h \frac{{\partial }^{2} h}{\partial {r}^{2}}$$

is defined on “◯” 205x in FIG. 2; and

$$〈 u 〉 , \frac{\partial h}{\partial r} , \frac{{\partial }^{3} h}{\partial {r}^{3}}$$

are defined on “+” 210x in FIG. 2.

From Eq. (8), the following equation can be obtained:

$$\frac{{h}^{n + 1} - {h}^{n}}{Δ t} = - \frac{1}{r} \frac{\partial }{\partial r} \{ \frac{{r ( {h}^{n} )}^{3}}{3 {C}_{a}} \frac{\partial }{\partial r} ( \frac{1}{r} \frac{\partial }{\partial r} \{ r \frac{\partial {h}^{n + 1}}{\partial r} \} ) \} - \frac{1}{r} \frac{\partial }{\partial r} ( {rh}^{n} {U}_{o} ) - {J}^{n}$$

$${h}^{n + 1} + Δ t [ \frac{1}{r} \frac{\partial }{\partial r} \{ \frac{{r ( {h}^{n} )}^{3}}{3 {C}_{a}} \frac{\partial }{\partial r} ( \frac{1}{r} \frac{\partial }{\partial r} \{ r \frac{\partial {h}^{n + 1}}{\partial r} \} ) \} ] = {h}^{n} - Δ t [ {J}^{n} + \frac{1}{r} \frac{\partial }{\partial r} ( {rh}^{n} {U}_{o} ) ]$$

which can be written as Equation (14) (below):

$${h}^{n + 1} + Δ {tM}^{n} {h}^{n + 1} = {h}^{n} - Δ t [ {J}^{n} + \frac{1}{r} \frac{\partial }{\partial r} ( {rh}^{n} {U}_{o} ) ] = {h}^{n} - Δ t {\tilde{J}}^{n} \qquad ( 14 )$$

where:

$${M}^{n} {h}^{n + 1} = \frac{1}{r} \frac{\partial }{\partial r} \{ \frac{{r ( {h}^{n} )}^{3}}{3 {C}_{a}} \frac{\partial }{\partial r} ( \frac{1}{r} \frac{\partial }{\partial r} \{ r \frac{\partial {h}^{n + 1}}{\partial r} \} ) \} = \frac{1}{r} \frac{\partial }{\partial r} \{ \frac{{r ( {h}^{n} )}^{3}}{3 {C}_{a}} \frac{\partial }{\partial r} ( \frac{1}{r} \frac{\partial {h}^{n + 1}}{\partial r} + \frac{{\partial }^{2} {h}^{n + 1}}{\partial {r}^{2}} ) \}$$

Introducing V defined on cell edges:

$${M}^{n} {h}^{n + 1} {\vert}_{r = {r}_{i}} = \frac{1}{r} \frac{\partial V}{\partial r} {\vert}_{r = {r}_{i}} = \frac{1}{{r}_{i}} \frac{1}{Δ r} ( {V}_{i + \frac{1}{2}} - {V}_{i - \frac{1}{2}} ) \\ where \\ {V}_{i + \frac{1}{2}} = \frac{{r ( {h}^{n} )}^{3}}{3 {C}_{a}} \frac{\partial }{\partial r} ( \frac{1}{r} \frac{\partial {h}^{n + 1}}{\partial r} + \frac{{\partial }^{2} {h}^{n + 1}}{\partial {r}^{2}} ) {\vert}_{r = {r}_{i + \frac{1}{2}}} \\ and \\ {V}_{i - \frac{1}{2}} = \frac{{r ( {h}^{n} )}^{3}}{3 {C}_{a}} \frac{\partial }{\partial r} ( \frac{1}{r} \frac{\partial {h}^{n + 1}}{\partial r} + \frac{{\partial }^{2} {h}^{n + 1}}{\partial {r}^{2}} ) {\vert}_{r = {r}_{i - \frac{1}{2}}} \qquad ( 15 )$$

### D. Arbitrary Lagrangian Eulerian (ALE) Slipping Contact Condition

In embodiments, to implement a slip condition at the edge of the droplet, an Arbitrary Lagrangian Eulerian (ALE) scheme is introduced. In embodiments, one method to account the change in the droplet size is to re-discretize the whole domain in each time step. However, such embodiments can be computationally expensive. In alternative embodiments, an ALE scheme is used so that only the last discretized element reflects the change due to slipping condition while uniformly discretized elements are kept for other parts of the domain. FIG. 3 depicts an ALE scheme for a moving contact line for a droplet 310 in which the domain 305 has been discretized into portions or cells according to embodiments of the present invention. In the depicted example, the height (e.g., h₁, h₂, . . . h_{N}) of the droplet is simulated at the cell centers of the discretized portions (e.g., r₁, r₂, . . . r_{N}), respectively. As the droplet 310 evaporates (illustration 300 to illustration 350), note that the slipping edge 305 in depiction 300 is simulated as moving in the last element (see the slipping edge 355 in depiction 350).

In embodiments, once the slipping contact velocity, Uₒ, is determined, the change of size of the last element can be written as a parameter, αΔr, where Δr is the element size after meshing. Therefore, using ALE, the last element can be written as (1−α)Δr while all other elements are written as Δr.

Here, α increases as evaporation continues and the droplet shrinks. In embodiments, to improve the numerical accuracy, a remeshing is done if α grows to exceed a certain limit. In this way, the new numerical scheme using ALE maintains numerical accuracy while keeping computational cost low.

Adopting ALE, Eq. (15) can be written as:

$$\frac{1}{{r}_{i}} \frac{1}{Δ r} ( {V}_{i + \frac{1}{2}} - {V}_{i - \frac{1}{2}} ) = \{ \begin{matrix}\frac{1}{{r}_{i}} \frac{1}{Δ r} ( {V}_{i + \frac{1}{2}} ) & i = 1 \\ \frac{1}{{r}_{i}} \frac{1}{Δ r} ( {V}_{i + \frac{1}{2}} - {V}_{i - \frac{1}{2}} ) & 2 \leq i \leq N - 1 \\ \frac{1}{{r}_{i}} \frac{1}{( 1 - α ) Δ r} ( - {V}_{i - \frac{1}{2}} ) & i = N\end{matrix} \qquad ( 16 )$$

Here, at i=1, boundary condition (B.C.) <u>=0 is applied and for i=N, h<u>=0 is applied. This yields:

$$\begin{matrix}{V}_{i + \frac{1}{2}} = \frac{{r ( {h}^{n} )}^{3}}{3 {C}_{a}} \frac{\partial }{\partial r} ( \frac{1}{r} \frac{\partial {h}^{n + 1}}{\partial r} + \frac{{\partial }^{2} {h}^{n + 1}}{\partial {r}^{2}} ) {\vert}_{r = {r}_{i + \frac{1}{2}}} = \frac{{r}_{i + \frac{1}{2}}}{3 {C}_{a}} {( \frac{{h}^{n} {\vert}_{r = {r}_{i + 1}} + {h}^{n} {\vert}_{r = {r}_{i}}}{2} )}^{3} \frac{1}{Δ r} ( W {\vert}_{r = {r}_{i + 1}} - W {\vert}_{r = {r}_{i}} ) \\ {V}_{i - \frac{1}{2}} = \frac{{r ( {h}^{n} )}^{3}}{3 {C}_{a}} \frac{\partial }{\partial r} ( \frac{1}{r} \frac{\partial {h}^{n + 1}}{\partial r} + \frac{{\partial }^{2} {h}^{n + 1}}{\partial {r}^{2}} ) {\vert}_{r = {r}_{i - \frac{1}{2}}} = \frac{{r}_{i - \frac{1}{2}}}{3 {C}_{a}} {( \frac{{h}^{n} {\vert}_{r = {r}_{i}} + {h}^{n} {\vert}_{r = {r}_{i - 1}}}{2} )}^{3} \frac{1}{Δ r} ( W {\vert}_{r = {r}_{i}} - W {\vert}_{r = {r}_{i - 1}} ) \\ where W = \frac{1}{r} \frac{\partial {h}^{n + 1}}{\partial r} + \frac{{\partial }^{2} {h}^{n + 1}}{\partial {r}^{2}} . \\ Then , & ( 17 ) \\ ( W {\vert}_{r = {r}_{i}} - W {\vert}_{r = {r}_{i - 1}} ) = \{ \begin{matrix}( W {\vert}_{r = {r}_{i}} - W {\vert}_{r = {r}_{i - 1}} ) & i = 1 B . C . \\ ( W {\vert}_{r = {r}_{i}} - W {\vert}_{r = {r}_{i - 1}} ) & 2 \leq i \leq N - 1 \\ ( W {\vert}_{r = {r}_{i}} - W {\vert}_{r = {r}_{i - 1}} ) & i = N B . C .\end{matrix} \\ \begin{matrix} {W}_{1} = \frac{1}{{r}_{1}} \frac{( {h}_{2} - {h}_{0} )}{2 Δ r} + \frac{( {h}_{2} - 2 {h}_{1} + {h}_{0} )}{Δ {r}^{2}} \\ = \frac{1}{{r}_{1}} \frac{( {h}_{2} - {H}_{1} )}{2 Δ r} + \frac{( {h}_{2} - {h}_{1} )}{Δ {r}^{2}}\end{matrix} {h}_{0} = {h}_{1} ∵ \frac{\partial h}{\partial r} {\vert}_{r = 0} = 0 \\ {W}_{i} = \frac{1}{{r}_{i}} \frac{( {h}_{i + 1} - {h}_{i - 1} )}{2 Δ r} + \frac{( {h}_{i + 1} - 2 {h}_{i} + {h}_{i - 1} )}{Δ {r}^{2}} \\ \begin{matrix}{W}_{N} = \frac{1}{{r}_{N}} \frac{( {h}_{N + 1} - {h}_{N - 1} )}{2 Δ r} + \frac{( {h}_{N + 1} - 2 {h}_{N} + {h}_{N - 1} )}{( 1 - α ) Δ {r}^{2}} \\ = \frac{1}{{r}_{N}} \frac{( \frac{- ( 1 + 2 α )}{( 1 - 2 α )} {h}_{N} - {h}_{N - 1} )}{2 Δ r} + \frac{( \frac{- ( 1 + 2 α )}{( 1 - 2 α )} {h}_{N} - 2 {h}_{N} + {h}_{N - 1} )}{( 1 - α ) Δ {r}^{2}} \\ = \frac{1}{{r}_{N}} \frac{( \frac{- ( 1 + 2 α )}{( 1 - 2 α )} {h}_{N} - {h}_{N - 1} )}{2 Δ r} + \frac{( \frac{- 3 + 2 α}{( 1 - 2 α )} {h}_{N} + {h}_{N - 1} )}{( 1 - α ) Δ {r}^{2}}\end{matrix} & ( 18 )\end{matrix}$$

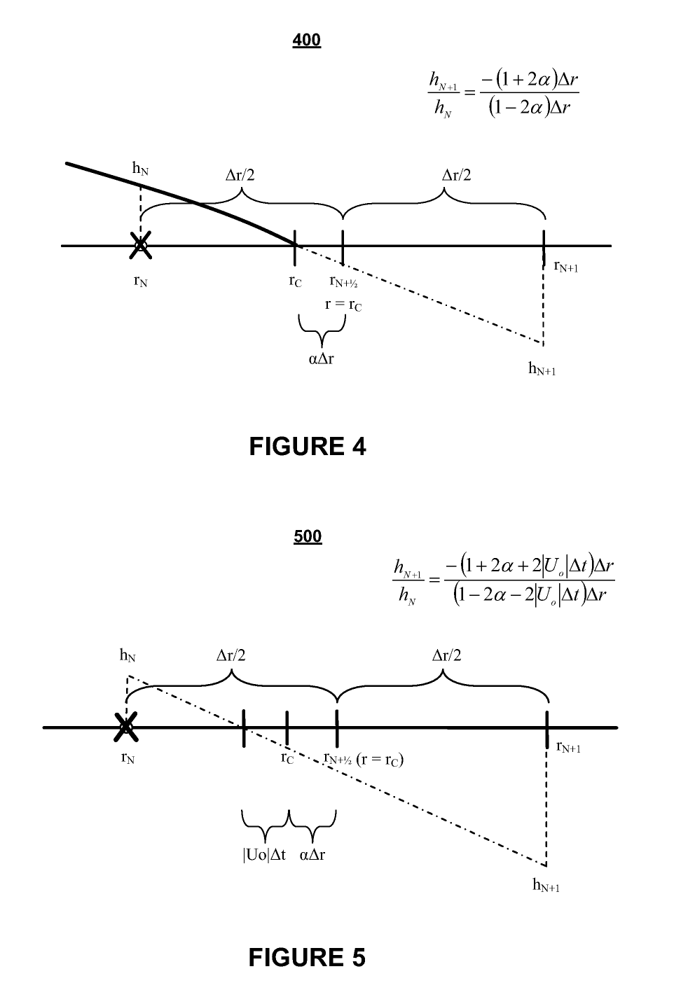

FIG. 4 illustrates the special discretization for the last element of the mesh according to embodiments of the present invention. FIG. 4 depicts the geometric relationship between h_{N} and h_{N+1} according to embodiments of the present invention.

The right hand side (RHS) term in Eq. (14) can be treated with ALE accordingly along with boundary conditions at r=0 and r=r_{c}, which yields:

$$\begin{matrix} \frac{1}{r} \frac{\partial }{\partial r} ( {rh}^{n} {U}_{o} ) {\vert}_{r = {r}_{i}} = \frac{1}{{r}_{i}} \frac{1}{Δ r} ( {Q}_{i + \frac{1}{2}} - {Q}_{i - \frac{1}{2}} ) & ( 19 ) \\ \frac{1}{{r}_{i}} \frac{1}{Δ r} ( {Q}_{i + \frac{1}{2}} - {Q}_{i - \frac{1}{2}} ) = \{ \begin{matrix}\frac{1}{{r}_{i}} \frac{1}{Δ r} ( {Q}_{i + \frac{1}{2}} ) & i = 1 \\ \frac{1}{{r}_{i}} \frac{1}{Δ r} ( {Q}_{i + \frac{1}{2}} - {Q}_{i - \frac{1}{2}} ) & 2 \leq i \leq N - 1 \\ \frac{1}{{r}_{i}} \frac{1}{( 1 - α ) Δ r} ( {Q}_{i + \frac{1}{2}} - {Q}_{i - \frac{1}{2}} ) & i = N\end{matrix} \\ where \\ {Q}_{i + \frac{1}{2}} = {rh}^{n} {U}_{o} {\vert}_{r = {r}_{i + \frac{1}{2}}} = {r}_{i + \frac{1}{2}} ( \frac{{h}^{n} {\vert}_{r = {r}_{i + 1}} + {h}^{n} {\vert}_{r = {r}_{i}}}{2} ) {U}_{o} {\vert}_{r = {r}_{i + \frac{1}{2}}} and \\ {Q}_{i - \frac{1}{2}} = {rh}^{n} {U}_{o} {\vert}_{r = {r}_{i - \frac{1}{2}}} = {r}_{i - \frac{1}{2}} ( \frac{{h}^{n} {\vert}_{r = {r}_{i}} + {h}^{n} {\vert}_{r = {r}_{i - 1}}}{2} ) {U}_{o} {\vert}_{r = {r}_{i - \frac{1}{2}}} & ( 20 )\end{matrix}$$

When i=N, Q_{i+1/2} has a special form that is modified due to the application of ALE configuration:

$${Q}_{i + \frac{1}{2}} = {rh}^{n} {U}_{o} {\vert}_{r = {r}_{i + \frac{1}{2}}} = {r}_{i + \frac{1}{2}} ( \frac{{h}^{n} {\vert}_{{\vert}_{r = {r}_{i + 1}}} + {h}^{n} {\vert}_{r = {r}_{i}}}{2} ) {U}_{o} {\vert}_{r = {r}_{i + \frac{1}{2}}} \\ where \\ {h}^{n} {\vert}_{{\vert}_{r = {r}_{i + 1}}} = {h}_{N + 1} = \frac{- ( 1 + 2 α + 2 \vert {U}_{o} \vert Δ t ) Δ r}{( 1 - 2 α - 2 \vert {U}_{o} \vert Δ t ) Δ r} {h}_{N} \qquad ( 21 )$$

FIG. 5 illustrates the special ALE discretization for the last element of the mesh for the right hand side (RHS) of Equation (14) according to embodiments of the present invention. FIG. 5 depicts the geometric relationship between h_{N} and h_{N+1} with the moving contact line according to embodiments of the present invention.

### E. Finite Difference Scheme for Two-Dimensional Embodiments

For the two-dimensional droplet embodiments, the finite difference scheme may be simulated as follows. From Eq. (11):

$$\frac{{h}^{n + 1} - {h}^{n}}{Δ t} = - \frac{\partial }{\partial x} ( \frac{{( {h}^{n} )}^{3}}{3 {C}_{a}} \frac{{\partial }^{3} {h}^{n + 1}}{\partial {x}^{3}} ) - \frac{\partial }{\partial x} ( {h}^{n} {U}_{o} ) - {J}^{n} \\ {h}^{n + 1} + Δ t [ \frac{\partial }{\partial x} ( \frac{{( {h}^{n} )}^{3}}{3 {C}_{a}} \frac{{\partial }^{3} {h}^{n + 1}}{\partial {x}^{3}} ) ] = {h}^{n} - Δ t [ {J}^{n} + \frac{\partial }{\partial x} ( {h}^{n} {U}_{o} ) ] \\ {h}^{n + 1} + Δ {tM}^{n} {h}^{n + 1} = {h}^{n} - Δ t [ {J}^{n} + \frac{\partial }{\partial x} ( {h}^{n} {U}_{o} ) ] = {h}^{n} - Δ t {\tilde{J}}^{n} \\ where \\ \begin{matrix}{M}^{n} {h}^{n + 1} {\vert}_{r = {r}_{i}} = \frac{\partial }{\partial x} ( \frac{{( {h}^{n} )}^{3}}{3 {C}_{a}} \frac{{\partial }^{3} {h}^{n + 1}}{\partial {x}^{3}} ) {\vert}_{r = {r}_{i}} \\ = \frac{\partial V}{\partial x} {\vert}_{r = {r}_{i}} \\ = \frac{1}{Δ x} ( {V}_{i + \frac{1}{2}} - {V}_{i - \frac{1}{2}} )\end{matrix} \qquad ( 22 )$$

from the boundary condition at x=0 and x=x_{c}.

$$\begin{matrix} \frac{1}{Δ x} ( {V}_{i + \frac{1}{2}} - {V}_{i - \frac{1}{2}} ) = \{ \begin{matrix}\frac{1}{Δ x} ( {V}_{i + \frac{1}{2}} ) & i = 1 \\ \frac{1}{Δ x} ( {V}_{i + \frac{1}{2}} - {V}_{i - \frac{1}{2}} ) & 2 \leq i \leq N - 1 \\ \frac{1}{( 1 - α ) Δ x} ( - {V}_{i - \frac{1}{2}} ) & i = N\end{matrix} & ( 23 ) \\ {V}_{i + \frac{1}{2}} = \frac{{( {h}^{n} )}^{3}}{3 {C}_{a}} \frac{{\partial }^{3} {h}^{n + 1}}{\partial {x}^{3}} {\vert}_{x = {x}_{i + \frac{1}{2}}} \frac{1}{3 {C}_{a}} {( \frac{{h}^{n} {\vert}_{x = {x}_{i + 1}} + {h}^{n} {\vert}_{x = {x}_{i}}}{2} )}^{3} \frac{1}{Δ x} ( W {\vert}_{x = {r}_{i + 1}} - W {\vert}_{x = {r}_{i}} ) \\ {V}_{i - \frac{1}{2}} = \frac{{( {h}^{n} )}^{3}}{3 {C}_{a}} \frac{{\partial }^{3} {h}^{n + 1}}{\partial {x}^{3}} {\vert}_{x = {x}_{i - \frac{1}{2}}} \frac{1}{3 {C}_{a}} {( \frac{{h}^{n} {\vert}_{x = {x}_{i}} + {h}^{n} {\vert}_{x = {x}_{i - 1}}}{2} )}^{3} \frac{1}{Δ x} ( W {\vert}_{x = {r}_{i}} - W {\vert}_{x = {r}_{i - 1}} ) \\ where W = \frac{{\partial }^{2} {h}^{n + 1}}{\partial {x}^{2}} & ( 24 ) \\ \frac{1}{Δ x} ( W {\vert}_{x = {x}_{i}} - W {\vert}_{x = {x}_{i - 1}} ) = \{ \begin{matrix}\frac{1}{Δ x} ( W {\vert}_{x = {x}_{i}} - W {\vert}_{x = {x}_{i - 1}} ) & i = 1 B . C . \\ \frac{1}{Δ x} ( W {\vert}_{x = {x}_{i}} - W {\vert}_{x = {x}_{i - 1}} ) & 2 \leq i \leq N - 1 \\ \frac{1}{Δ x} ( W {\vert}_{x = {x}_{i}} - W {\vert}_{x = {x}_{i - 1}} ) & i = N B . C .\end{matrix} \\ where \\ {W}_{1} = \frac{( {h}_{2} - 2 {h}_{1} + {h}_{0} )}{Δ {x}^{2}} = \frac{( {h}_{2} - {h}_{1} )}{Δ {x}^{2}} , \\ {W}_{i} = \frac{( {h}_{i + 1} - 2 {h}_{i} + {h}_{i - 1} )}{Δ {x}^{2}} , and \\ {W}_{N} = \frac{1}{( 1 - α ) Δ {x}^{2}} ( \frac{( - 3 + 2 α )}{( 1 - 2 α )} {h}_{N} + {h}_{N - 1} ) . & ( 25 )\end{matrix}$$

In embodiments, the right hand side (RHS) term in Eq. (22) with ALE may be written as:

$$\begin{matrix} \frac{\partial }{\partial x} ( {h}^{n} {U}_{o} ) {\vert}_{r = {r}_{i}} = \frac{1}{Δ x} ( {Q}_{i + \frac{1}{2}} - {Q}_{i - \frac{1}{2}} ) & ( 26 ) \\ \frac{1}{Δ x} ( {Q}_{i + \frac{1}{2}} - {Q}_{i - \frac{1}{2}} ) = \{ \begin{matrix}\frac{1}{Δ x} ( {Q}_{i + \frac{1}{2}} ) & i = 1 \\ \frac{1}{Δ x} ( {Q}_{i + \frac{1}{2}} - {Q}_{i - \frac{1}{2}} ) & 2 \leq i \leq N - 1 \\ \frac{1}{( 1 - α ) Δ x} ( {Q}_{i + \frac{1}{2}} - {Q}_{i - \frac{1}{2}} ) & i = N\end{matrix} \\ where \\ {Q}_{i + \frac{1}{2}} = {h}^{n} {U}_{o} {\vert}_{r = {r}_{i + \frac{1}{2}}} = ( \frac{{h}^{n} {\vert}_{r = {r}_{i + 1}} + {h}^{n} {\vert}_{r = {r}_{i}}}{2} ) {U}_{o} {\vert}_{r = {r}_{i + \frac{1}{2}}} and \\ {Q}_{i - \frac{1}{2}} = {h}^{n} {U}_{o} {\vert}_{r = {r}_{i - \frac{1}{2}}} = ( \frac{{h}^{n} {\vert}_{r = {r}_{i}} + {h}^{n} {\vert}_{r = {r}_{i - 1}}}{2} ) {U}_{o} {\vert}_{r = {r}_{i - \frac{1}{2}}} & ( 27 )\end{matrix}$$

As explained in Eq. (21) for the axisymmetric case, when i=N for a 2D case, Q_{i+1/2} has a special form for ALE configuration:

$${Q}_{i + \frac{1}{2}} = {rh}^{n} {U}_{o} {\vert}_{r = {r}_{i + \frac{1}{2}}} = {r}_{i + \frac{1}{2}} ( \frac{{h}^{n} {\vert}_{{\vert}_{r = {r}_{i + 1}}} + {h}^{n} {\vert}_{r = {r}_{i}}}{2} ) {U}_{o} {\vert}_{r = {r}_{i + \frac{1}{2}}} \\ where \\ {h}^{n} {\vert}_{{\vert}_{r = {r}_{i + 1}}} = {h}_{N + 1} = \frac{- ( 1 + 2 α + 2 \vert {U}_{o} \vert Δ t ) Δ r}{( 1 - 2 α - 2 \vert {U}_{o} \vert Δ t ) Δ r} {h}_{N} \qquad ( 28 )$$

### F. Slipping Contact Line Velocity Model

In embodiments of the numerical simulation, the slipping contact line velocity, Uₒ, may be determined by Hoffmann's model, in which the slipping contact line velocity is determined by the contact angle, θ, surface tension, σ, and viscosity, μ. Although Hoffman's model is used in embodiments depicted herein, one skilled in the art shall recognize that other methods may be employed to obtain the slipping contact line velocity.

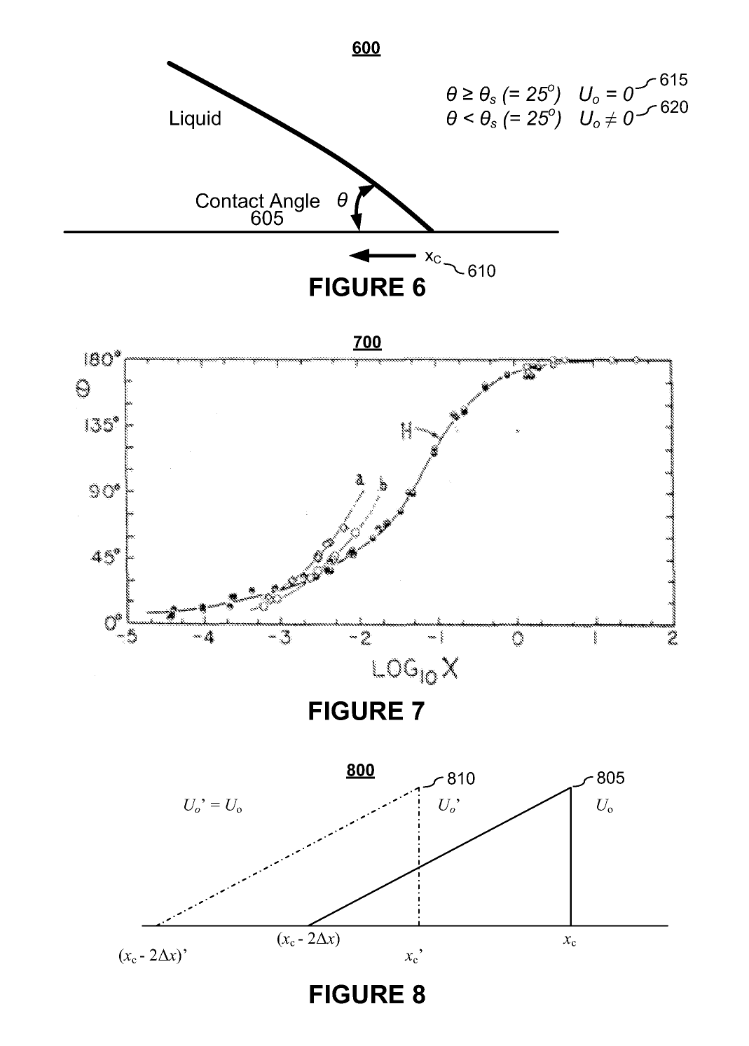

FIG. 6 graphically illustrates the relationship between the critical contact angle, θₛ, and the contact angle, θ. In embodiments, if the contact angle, θ 605, is greater than or equal to the critical contact angle, θₛ, the contact line does not move. That is, the contact line velocity is zero, Uₒ=0. In the illustrated embodiment, the critical contact angle is 25 degrees, although other critical contact angles may be selected. When the contact angle, θ 650, is less than the critical angle, θₛ, the contact line movement 610 is initiated toward the center of the droplet representing the shrinkage of the droplet. Thus, in embodiments, the slipping contact line velocity may be determined according to Equation (29) below:

$${U}_{o} = \frac{σ}{μ} \{ {H}^{- 1} ( θ ) - {H}^{- 1} ( {θ}_{s} ) \} \qquad ( 29 )$$

where Hoffman's correlation is given by the curve χ=H⁻¹(θ). FIG. 7 depicts a graph 700 showing a correlation curve for Hoffman's model for a moving contact line.

In embodiments, while the slipping contact line is determined by the contact angle, the profile of the velocity inside the droplet is not uniform inside the droplet. In embodiments of this simulation, it may be assumed to be linearly dissipating from the edge of the droplet toward the center of the droplet. In embodiments, the profile of the contact line velocity moves with the moving contact line to represent slipping contact line.

FIG. 8 shows two velocity profile 805 and 810 according to embodiments of the present invention. The profile 805 of Uₒ represents a smooth profile from the contact edge toward the center of the droplet, and the profile 810 of Uₒ′ represents the moving profile as the contact edge moves. In embodiments, the contact line velocity may be linearly diminished to zero after two discretized elements toward the center of the droplet; however, in embodiments, one skilled in the art shall recognize that how the contact line changes in the domain may be optionally changed and that other diminishing rate may be employed. It shall be noted that although linear profiles are depicted in FIG. 8, one skilled in the art shall recognize that other smooth profiles may be used.

### G. Methods for Simulating Droplet Height

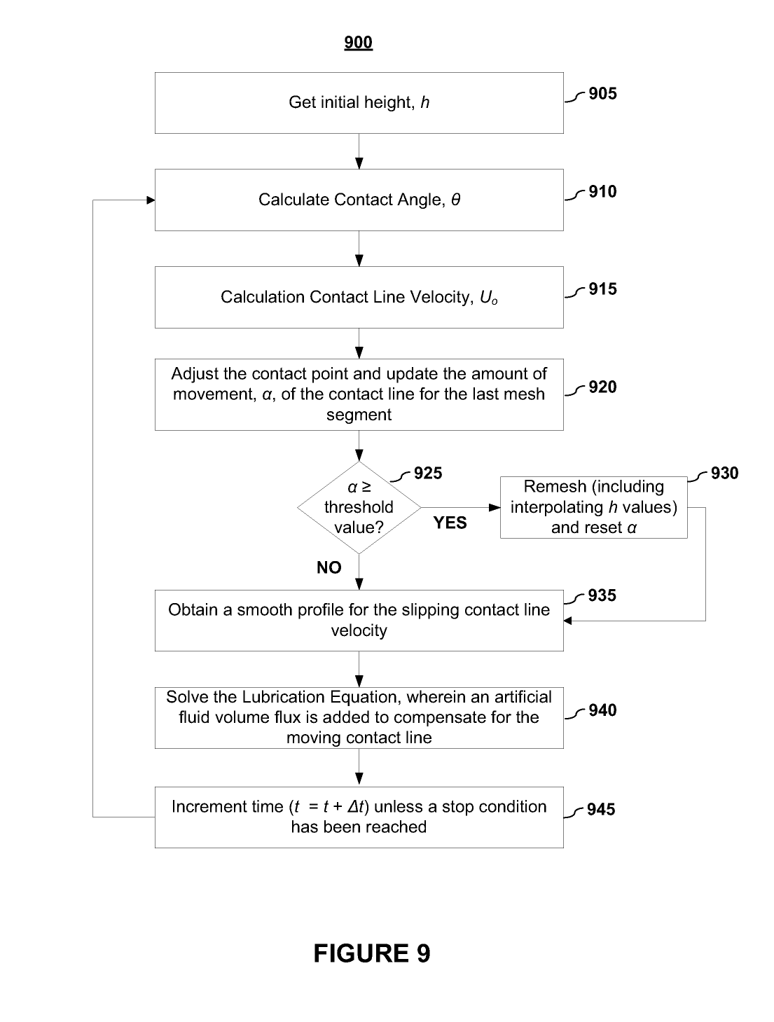

Turning now to FIG. 9, a flowchart depicts methods for simulating the evaporation of a droplet according to embodiments of the present invention. As depicted in FIG. 9, in embodiments, an initial height profile, h, of the droplet may be used to obtain or set (905) the discretized height values. One skilled in the art shall recognize that the height profile and/or the height values may be obtained from experimental data. The contact angle, θ, is calculated (910). One skilled in the art shall recognize that the contact angle, θ, may be calculated using geometry or also obtained from experimental data.

Given the contact angle, θ, the contact line velocity, Uₒ, of the slipping contact line is calculated (915). In embodiments, as previously noted, the contact line velocity may be determined using Hoffman's model, although other methods may be employed.

The contact point for the droplet is adjusted (920) based upon the slipping velocity and the time step. The percent amount that the contact line has slipped or moved, α, in decimal form in the last mesh segment is also updated (920). It shall be noted that if the contact line velocity, Uₒ, is zero, there will be no adjustment to the contact point or to the decimal percent amount of movement, α.

At step 925, the amount of movement, α, is checked to determine if it is greater than or equal to a threshold amount. If it is greater than or equal to a threshold amount, the domain is remeshed (930). One skilled in the art shall recognize that the condition can be set at just greater than (rather than greater than or equal to) a threshold by adjusting the threshold level. In embodiments, α may be set at 0.25, meaning that the contact edge has moved 25% of the last discretized cell or element; however, it shall be noted that other values may be selected.

In embodiments, remeshing involves re-discretizing the domain into cells and interpolating the height values of the droplet at the remeshed cell centers. In embodiments, the cells may be remeshed into uniform cells, although other configurations may be used. When the domain is remeshed, the contact line of the droplet will be at the end of the domain; therefore, the amount of movement, α, is set (930) to zero to reflect this change.

If the amount of movement, α, is not greater than or equal to a threshold amount, a smooth profile, such as one depicted in FIG. 8, is obtain (935) for the slipping contact line.

The lubrication equation is solved (940), wherein an artificial fluid volume flux is added to compensate for the moving contact line. Note that when the contact line is adjusted at step 920, a portion of the droplet volume is lost. To compensate for the lost fluid volume, that portion is added back when solving the lubrication equation.

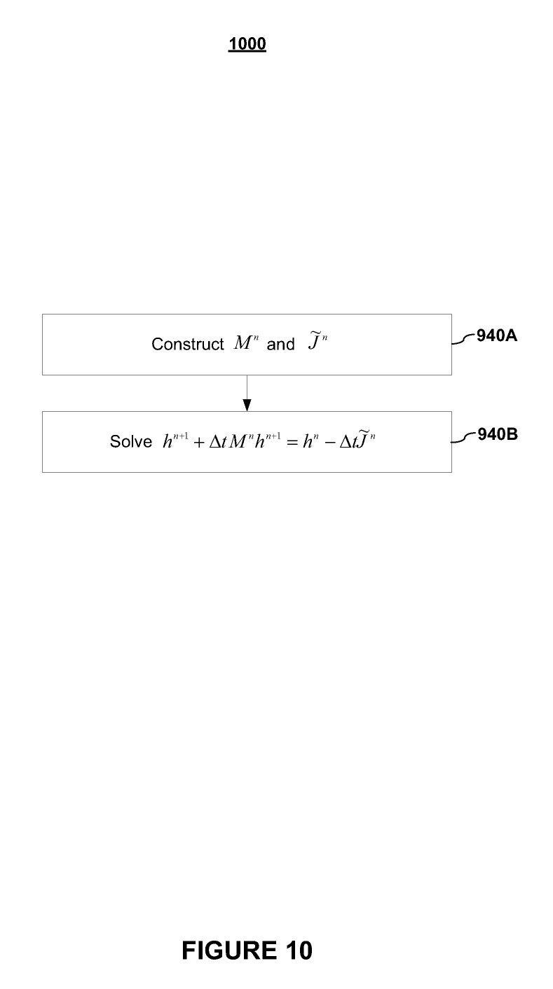

FIG. 10 depicts an embodiment of a method for solving the lubrication equation. One skilled in the art shall recognize that discretization of the partial differential lubrication equation results in a system of linear equations. As previously explained above, the lubrication equation can be solved by constructing Mⁿ and \tilde{J}ⁿ (940A) and solving (940B) Equation (14) or (22), which is reproduced below:

hⁿ⁺¹+ΔtMⁿhⁿ⁺¹=hⁿ−Δt\tilde{J}ⁿ

Unless a stop condition has been reached (945), the time step is incremented (945) and the process iterates by returning to step 910. In embodiments, the stop conditions may be one or more of: (1) a set number of iterations have occurred; (2) the droplet has reached a gel state; (3) the amount of change of the contact line between a set number of iteration is below a threshold; and (4) a set amount of time has elapsed. One skilled in the art shall recognize that other stop conditions may be employed.

### H. Numerical Results

Presented below are some examples of droplet height simulations according to embodiments of the present invention. In the following two examples, the initial height of the droplet was hₒ=18.725 (μm), the initial width was Rₒ=63.496 (μm), the surface tension was σ=0.0365 (N/m), the viscosity was μ=0.00485 (N s/m²), the evaporation rate was J=2.0e−11 (m/s), and the numerical time step was Δt=0.005852 (sec).

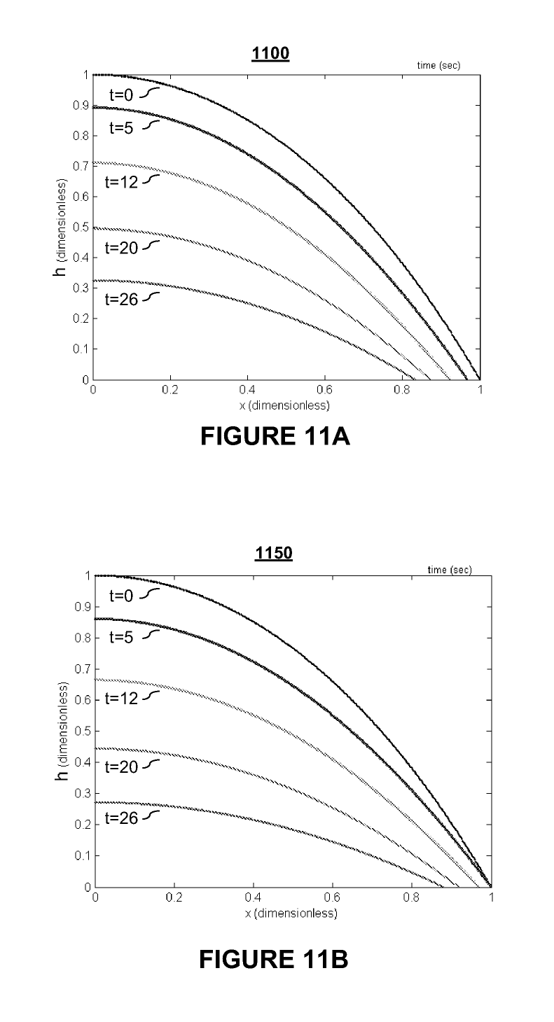

FIG. 11A depicts a first example of droplet height simulation according to embodiments of the present invention. In this first example, the slipping velocity is set as a constant, Uₒ=0.4069 μm/s. The change in the droplet height over a period of 26 seconds is plotted in FIG. 11B. During this time period, a total of 282 remeshings were performed.

FIG. 11B depicts a second example of droplet height simulation according to embodiments of the present invention. In the second example, Hoffman's slipping contact line model is used. The change in the droplet height over a period of 26 seconds is plotted in FIG. 11B. During the 26 seconds of computation time, a total of 199 remeshings were performed. It is clearly seen in FIG. 11B that for the initial 5 seconds when the contact line is larger than critical contact angle, θₛ=25°, the edge of the droplet is not moved.

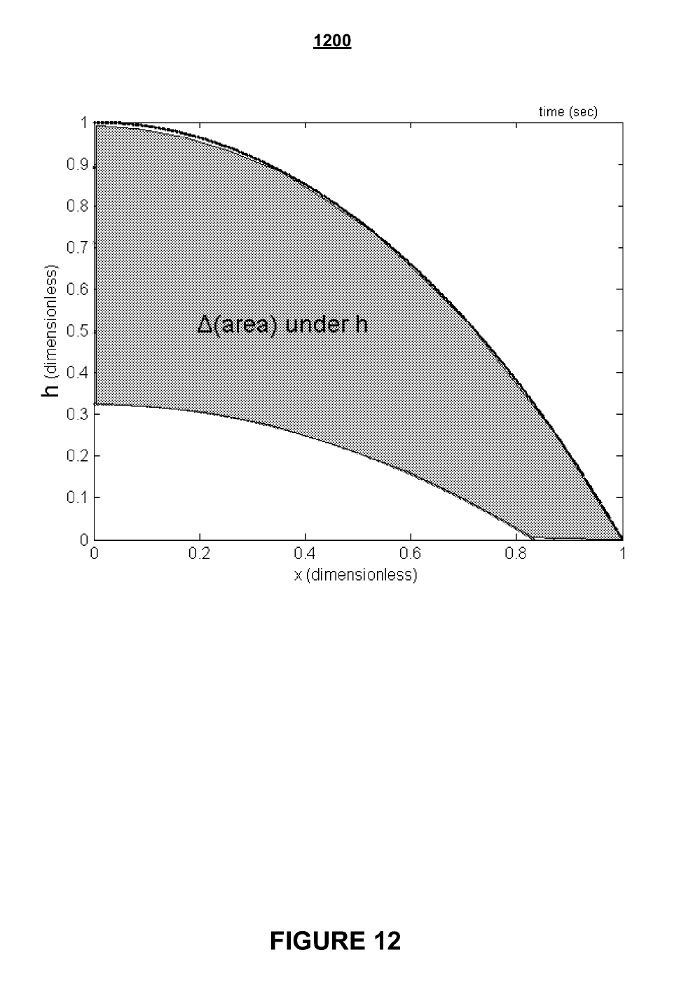

To check the droplet mass conservation for the first example depicted in FIG. 11A, the dimensionless area change, 0.49714, is compared with the computed total evaporation, ∫₀^{t}^{_{end}}(∫₀^{x}^{_{c}}Jdx)dt=0.49717. Note that there is close correlation between these two values indicating that the droplet evaporation simulation conserves mass. FIG. 12 depicts the mass conservation for a two-dimensional droplet evaporation simulation according to embodiments of the present invention. The shaded area represents the change between initial and final profile of the droplet.

### II. Mass-Conserving Methods for Solving the Solute Convection/Diffusion Equation with Slipping Contact Line

In the previous section, a lubrication model was presented with methods for solving the simulation of droplet evaporation with slipping contact line. The methods incorporated fluid velocity while the finite difference ALE algorithm conserved the droplet mass very well.

Since the solute deposit pattern can be important to the application of industrial printing technologies to manufacturing, being able to predict the solute deposit pattern is important to simulation technology with droplet evaporation simulation in mind. This section discusses extending the methodologies for solving the lubrication equation with slipping contact line to solving the solute convection/diffusion equation. That is, in embodiments, the finite difference Arbitrary-Lagrangian-Eulerian (ALE) scheme is extended to solve the solute convection/diffusion equation with slipping contact line. The variable to solve from the solute equation is the solute concentration. Since how to solve the lubrication equation with slipping contact line was disclosed in the previous section, here it is assumed that the lubrication equation is solved in a time step and the purpose is to solve the solute equation to obtain the new solute concentration.

In embodiments, the finite difference algorithm for the solute equation is an upwind ALE scheme. In embodiments, a uniform finite difference mesh is created. Due to the moving contact line, the size of the last mesh element or cell shrinks at the end of a time step when the contact model decides the contact line would move. In embodiments, when the last mesh shrinks to a certain pre-decided size, a remeshing is done, at which moment a new uniform mesh is created and the old variable values at cell centers are interpolated to the cell centers of the new mesh. Since for most of the time the size of the last mesh is different from the other mesh portions, a special discretization is needed that for the upwind finite differencing. In embodiment, the methodology is such that, when the contact line moves (inward), a special flux is added to the mesh right next to the slipping contact line when the solute equation is solved. Then, the mesh will shrink a little bit according to the slipping velocity. Since the flux of solute mass added when solving the solute equation is equivalent or nearly equivalent to the amount of solute that is lost when the last mesh shrinks, the solute mass conservation is achieved.

### A. Solute Equations for Axisymmetric Embodiments

In embodiments, the mathematical description of solute conservation may be written as:

$$\frac{\partial ( hC )}{\partial t} = - \frac{1}{r} \frac{\partial }{\partial r} \{ rh 〈 u 〉 C \} + \frac{1}{{S}_{c}} \frac{1}{r} \frac{\partial }{\partial r} \{ {rhDC}_{r} \} \\ 〈 u 〉 = \frac{{h}^{2}}{3 {C}_{a}} \frac{\partial }{\partial r} ( \frac{1}{r} \frac{\partial }{\partial r} \{ r \frac{\partial h}{\partial r} \} ) + {U}_{o} \qquad ( II \text{-} 1 )$$

In the equation above, h is the droplet height, C is the solute concentration, D is the diffusivity, <u> is the average velocity, S_{c} is dimensionless Schmidt like number,

$${S}_{c} = \frac{2 {J}_{o} {R}_{o}}{{D}_{o}} ,$$

and Dₒ is the initial diffusivity. All equations are written in dimensionless form by normalization in which r is normalized by Rₒ, initial radius of the droplet, and h is normalized by hₒ, the initial droplet height. The time scale is

$$\frac{{h}_{o}}{2 {J}_{o}}$$

in which Jₒ is the evaporation rate.

Introducing the relation of W=hC yields:

$$\frac{\partial W}{\partial t} = - \frac{1}{r} \frac{\partial }{\partial r} \{ r 〈 u 〉 W \} + \frac{1}{{S}_{c}} \frac{1}{r} \frac{\partial }{\partial r} \{ rhD \frac{\partial ( W / h )}{\partial r} \} \\ \frac{\partial W}{\partial t} = \frac{1}{r} \frac{\partial }{\partial r} \{ \frac{{rh}^{2} W}{3 {C}_{a}} \frac{\partial }{\partial r} ( \frac{1}{r} \frac{\partial }{\partial r} \{ r \frac{\partial h}{\partial r} \} ) + {rU}_{o} W \} + \frac{1}{{S}_{c}} \frac{1}{r} \frac{\partial }{\partial r} ( rhD \frac{\partial ( W / h )}{\partial r} ) \qquad ( II \text{-} 2 )$$

where Ca is a capillary number,

$$Ca = \frac{2 {J}_{o} μ}{{ɛ}^{4} σ} and ɛ = \frac{{h}_{o}}{{R}_{o}}$$

in which σ is surface tension and μ is viscosity of the fluid. Uₒ(r) is the slipping velocity at z=0. It is such that Uₒ=0 if r<<r_{c} and Uₒ is related to the contact angleθ, and material properties, such as surface tension and viscosity, at r=r_{c}.

Equation (II-2) can be solved numerically along with the following boundary conditions:

$$r = 0 \\ \frac{\partial h}{\partial r} = 0 \\ and \\ \frac{\partial C}{\partial r} = 0 \\ r = {r}_{c} \\ h = 0 , \\ h 〈 u 〉 C = 0 \\ and \\ Dh \frac{\partial C}{\partial r} = 0 \qquad ( II \text{-} 3 )$$

### B. The Finite Difference Scheme for Axisymmetric Embodiments

The following describes embodiments of numerical procedures to solve the solute equation, Eq. (II-2), with slipping contact line using finite difference.

Similar to the finite difference grid shown in FIG. 2, a finite difference grid can be established along the computational domain. In embodiments, the unknown C may be defined at cell centers (e.g., ◯ in the grid depicted in FIG. 2), and the average velocity <u> may be defined at cell edges (e.g., + is the grid depicted in FIG. 2). Given the droplet height hⁿ, solute concentration Cⁿ, and Wⁿ for t=tⁿ, the finite difference seeks to obtain hⁿ⁺¹, Cⁿ⁺¹, and Wⁿ⁺¹ for tⁿ⁺¹=tⁿ+Δt, where Δt is the time step or increment. In embodiments, the droplet height hⁿ⁺¹ may be calculated using the teachings of the prior section; it is deemed as given for the solute equation. Embodiments of the following methodologies solve Wⁿ⁺¹, and Cⁿ⁺¹ can be calculated from Wⁿ⁺¹/hⁿ⁺¹.

$$\begin{matrix}{W}^{n + 1} + Δ t [ \frac{1}{r} \frac{\partial }{\partial r} \{ \frac{{r ( {h}^{n + 1} )}^{2} {W}^{n + 1}}{3 {C}_{a}} \frac{\partial }{\partial r} ( \frac{1}{r} \frac{\partial }{\partial r} \{ r \frac{\partial {h}^{n + 1}}{\partial {r}_{o}} \} ) \} - \frac{1}{{S}_{c}} \frac{1}{r} \frac{\partial }{\partial r} ( {rh}^{n + 1} D \frac{\partial ( {W}^{n + 1} / {h}^{n + 1} )}{\partial r} ) ] = {W}^{n} - Δ t \frac{1}{r} \frac{\partial }{\partial r} \{ {rU}_{o} {W}^{n} \} = {\tilde{W}}^{n} \\ {W}^{n + 1} + Δ {tN}^{n + 1} {W}^{n + 1} = {W}^{n} - Δ t [ \frac{1}{r} \frac{\partial }{\partial r} ( {rU}_{o} {W}^{n} ) ] = {\tilde{W}}^{n} \\ where & ( II \text{-} 4 ) \\ {N}^{n + 1} {W}^{n + 1} = \frac{1}{r} \frac{\partial }{\partial r} \{ r 〈 v 〉 {W}^{n + 1} \} - \frac{1}{{S}_{c}} \frac{1}{r} \frac{\partial }{\partial r} ( {rh}^{n + 1} D \frac{\partial ( {W}^{n + 1} / {h}^{n + 1} )}{\partial r} ) \\ 〈 v 〉 = \frac{{( {h}^{n + 1} )}^{2}}{3 {C}_{a}} \frac{\partial }{\partial r} ( \frac{1}{r} \frac{\partial }{\partial r} \{ r \frac{\partial {h}^{n + 1}}{\partial r} \} ) & ( II \text{-} 5 )\end{matrix}$$

The moving contact line can greatly influence the solute concentration near the moving contact line. Therefore, in embodiments, the Arbitrary Lagrangian Eulerian (ALE) scheme may be extended to the solute equations. In embodiments, the last element receives special attention to reflect the slipping condition while other uniformly discretized elements in the domain kept the size. The change of size of the last element is written with a parameter, αΔr, where Δr is the element size in the mesh. The parameter α changes as evaporation continues and the contact line moves and represents the percentage amount of change in decimal form. In embodiments, to preserve numerical accuracy, a remeshing is done when α grows over a certain threshold limit. As discussed in the prior section, in this way, the new numerical scheme using ALE maintains the numerical accuracy while keeping the computational costs low.

Because the advection term in Eq. (II-5) can cause numerical instability problem when 1/S_{c} becomes very small at later stage of evaporation, in embodiment, the term is discretized using an upwind scheme. In the i^{th} cell:

$$\frac{1}{r} \frac{\partial }{\partial r} \{ r {〈 v 〉}^{n + 1} {W}^{n + 1} \} {\vert}_{i} = \frac{1}{{r}_{i}} \frac{( {r}_{i + 1 / 2} {〈 v 〉}_{i + 1 / 2}^{n + 1} {W}_{i + 1 / 2}^{n + 1} - {r}_{i - 1 / 2} {〈 v 〉}_{i - 1 / 2}^{n + 1} {W}_{i - 1 / 2}^{n + 1} )}{Δ r} \\ if ( {〈 v 〉}_{i + 1 / 2}^{n + 1} > 0 ) {W}_{i + 1 / 2}^{n + 1} = {W}_{i}^{n + 1} \\ if ( {〈 v 〉}_{i + 1 / 2}^{n + 1} \leq 0 ) {W}_{i + 1 / 2}^{n + 1} = {W}_{i + 1}^{n + 1} \\ if ( {〈 v 〉}_{i - 1 / 2}^{n + 1} > 0 ) {W}_{i - 1 / 2}^{n + 1} = {W}_{i - 1}^{n + 1} \\ if ( {〈 v 〉}_{i - 1 / 2}^{n + 1} \leq 0 ) {W}_{i - 1 / 2}^{n + 1} = {W}_{i}^{n + 1} . \qquad ( II \text{-} 6 )$$

Due to the ALE algorithm, Eq. (II-6), for the last element, which can be shorter than the other elements in the mesh, is given by:

$$\frac{1}{r} \frac{\partial }{\partial r} \{ r {〈 v 〉}^{n + 1} {W}^{n + 1} \} {\vert}_{last element} = \frac{1}{{r}_{i}} \frac{( - {r}_{i - 1 / 2} {〈 v 〉}_{i - 1 / 2}^{n + 1} {W}_{i - 1 / 2}^{n + 1} )}{( 1 - α ) Δ r} \qquad ( II \text{-} 7 )$$

where the boundary condition at the end, <u>_{i+1/2}ⁿ⁺¹W_{i+1/2}ⁿ⁺¹=0 has been applied.

Similarly, the right hand side (RHS) term is discretized with the upwind idea:

$$\frac{1}{r} \frac{\partial }{\partial r} \{ {rU}_{o} {W}^{n} \} {\vert}_{i} = \frac{1}{{r}_{i}} \frac{( {r}_{i + 1 / 2} {U}_{o} {\vert}_{i + 1 / 2} {W}_{i + 1 / 2}^{n} - {r}_{i - 1 / 2} {U}_{o} {\vert}_{i - 1 / 2} {W}_{i - 1 / 2}^{n} )}{Δ r} \\ if ( {U}_{o} {\vert}_{i + 1 / 2} > 0 ) {W}_{i + 1 / 2}^{n} = {W}_{i}^{n} \\ if ( {U}_{o} {\vert}_{i + 1 / 2} \leq 0 ) {W}_{i + 1 / 2}^{n} = {W}_{i + 1}^{n} \\ if ( {U}_{o} {\vert}_{i - 1 / 2} > 0 ) {W}_{i - 1 / 2}^{n} = {W}_{i - 1}^{n} \\ if ( {U}_{o} {\vert}_{i - 1 / 2} \leq 0 ) {W}_{i - 1 / 2}^{n} = {W}_{i}^{n} \qquad ( II \text{-} 8 )$$

In embodiments, for the last element, a special flux is added at the contact line when it is moving:

$$\begin{matrix}\frac{1}{r} \frac{\partial }{\partial r} \{ {rU}_{o} {W}^{n} \} {\vert}_{last element} = \frac{1}{{r}_{i}} \frac{( {r}_{i + 1 / 2} {U}_{o} {\vert}_{i + 1 / 2} {W}_{i + 1 / 2}^{n} - {r}_{i - 1 / 2} {U}_{o} {\vert}_{i - 1 / 2} {W}_{i - 1 / 2}^{n} )}{( 1 - α ) Δ r} \\ {r}_{i + 1 / 2} {U}_{o} {\vert}_{i + 1 / 2} {W}_{i + 1 / 2}^{n} = {( {rU}_{o} {W}^{n} )}_{r = {r}_{c}} = {( {rU}_{o} ( \frac{1}{2} {h}^{n} {C}^{n} ) )}_{r = {r}_{c}} \\ Therefore , & ( II \text{-} 9 ) \\ \frac{1}{{r}_{i}} \frac{( {r}_{i + 1 / 2} {U}_{o} {\vert}_{i + 1 / 2} {W}_{i + 1 / 2}^{n} - {r}_{i - 1 / 2} {U}_{o} {\vert}_{i - 1 / 2} {W}_{i - 1 / 2}^{n} )}{( 1 - α ) Δ r} = \frac{1}{{r}_{i}} \frac{( {( {rU}_{o} {W}_{i}^{n} )}_{r = {r}_{c}} - {r}_{i - 1 / 2} {U}_{o} {\vert}_{i - 1 / 2} {W}_{i - 1 / 2}^{n} )}{( 1 - α ) Δ r} = \frac{1}{{r}_{i}} \frac{( {( {rU}_{o} ( \frac{1}{2} {h}^{n} {C}^{n} ) )}_{r = {r}_{c}} - {r}_{i - 1 / 2} {U}_{o} {\vert}_{i - 1 / 2} {W}_{i - 1 / 2}^{n} )}{( 1 - α ) Δ r} & ( II \text{-} 10 )\end{matrix}$$

The diffusion term in Eq. (II-5) may be discretized as follows:

$$\begin{matrix}\frac{1}{{S}_{c}} \frac{1}{r} \frac{\partial }{\partial r} ( r ( {H}^{n + 1} - f ) D \frac{\partial ( {W}^{n + 1} / ( {H}^{n + 1} - f ) )}{\partial r} ) {\vert}_{i} = \frac{1}{{S}_{C}} \frac{1}{r} \frac{\partial V}{\partial r} {\vert}_{i} = \frac{1}{{S}_{c}} \frac{{V}_{i + \frac{1}{2}} - {V}_{i - \frac{1}{2}}}{{r}_{i} Δ r} = \frac{{V}_{i + \frac{1}{2}} - {V}_{i - \frac{1}{2}}}{{S}_{c} ( i - \frac{1}{2} ) Δ {r}^{2}} \\ V = r ( {H}^{n + 1} - f ) D \frac{\partial ( {W}^{n + 1} / ( {H}^{n + 1} - f ) )}{\partial r} & ( II \text{-} 11 ) \\ {V}_{i + \frac{1}{2}} = {r}_{i + \frac{1}{2}} ( \frac{{( {H}^{n + 1} - f )}_{i} + {( {H}^{n + 1} - f )}_{i + 1}}{2} ) {D}_{i + \frac{1}{2}} ( \frac{{W}_{i + 1}^{n + 1} / ( {H}_{i + 1}^{n + 1} - f ) {W}_{i}^{n + 1} / ( {H}_{i}^{n + 1} - f )}{Δ r} ) \\ {V}_{i - \frac{1}{2}} = {r}_{i - \frac{1}{2}} ( \frac{{( {H}^{n + 1} - f )}_{i} + {( {H}^{n + 1} - f )}_{i - 1}}{2} ) {D}_{i - \frac{1}{2}} ( \frac{{W}_{i}^{n + 1} / ( {H}_{i}^{n + 1} - f ) - {W}_{i - 1}^{n + 1} / ( {H}_{i - 1}^{n + 1} - f )}{Δ r} ) & ( II \text{-} 12 )\end{matrix}$$

For the last element, using boundary condition:

$$\frac{1}{{S}_{c}} \frac{1}{r} \frac{\partial V}{\partial r} {\vert}_{last element} = \frac{- {V}_{i - \frac{1}{2}}}{{S}_{c} {r}_{i} ( 1 - α ) Δ r} = \frac{- {V}_{i - \frac{1}{2}}}{{S}_{c} ( i - \frac{1}{2} ) ( 1 - α ) Δ {r}^{2}} \\ {V}_{i - \frac{1}{2}} = {r}_{i - \frac{1}{2}} ( \frac{{( {H}^{n + 1} - f )}_{i} + {( {H}^{n + 1} - f )}_{i - 1}}{2} ) {D}_{i - \frac{1}{2}} ( \frac{{W}_{i}^{n + 1} / ( {H}_{i}^{n + 1} - f ) - {W}_{i - 1}^{n + 1} / ( {H}_{i - 1}^{n + 1} - f )}{Δ r} ) \qquad ( II \text{-} 13 )$$

### C. Solute Equations for 2D Embodiments

In embodiments, if one dimension of the structure is much longer than the other, it can be modeled that the variation through the longer dimension is small. Therefore, the problem can be further simplified to a two-dimensional problem instead of an axisymmetric problem. In such embodiments, the solute conservation for the two-dimensional case may be written as:

$$\frac{\partial ( hC )}{\partial t} = - \frac{\partial }{\partial x} \{ 〈 u 〉 C \} + \frac{1}{{S}_{c}} \frac{\partial }{\partial x} \{ {hDC}_{x} \} \\ 〈 u 〉 = \frac{{( h )}^{2}}{3 {C}_{a} h} \frac{{\partial }^{3} h}{\partial {x}^{3}} + {U}_{o} \qquad ( II \text{-} 14 )$$

Introducing W=hC,

$$\frac{\partial W}{\partial t} = - \frac{\partial }{\partial x} \{ 〈 u 〉 W \} + \frac{1}{{S}_{c}} \frac{\partial }{\partial x} \{ hD \frac{\partial ( W / h )}{\partial x} \} \\ \frac{\partial W}{\partial t} = - \frac{\partial }{\partial x} \{ \frac{{( h )}^{2} W}{3 {C}_{a}} \frac{{\partial }^{3} h}{\partial {x}^{3}} + {U}_{o} W \} + \frac{1}{{S}_{c}} \frac{\partial }{\partial x} ( hD \frac{\partial ( W / h )}{\partial x} ) \qquad ( II \text{-} 15 )$$

In embodiments, Equation (II-14) may be solved numerically with the boundary conditions:

$$x = 0 \\ \frac{\partial h}{\partial x} = 0 \\ and \\ \frac{\partial C}{\partial x} = 0 \\ x = {x}_{c} \\ h = 0 , \\ h 〈 u 〉 C = 0 , \\ and \\ Dh \frac{\partial C}{\partial x} = 0 \qquad ( II \text{-} 16 )$$

### D. The Finite Difference Scheme for 2D Embodiments

After solving hⁿ⁺¹ for the lubrication equations, to calculate Cⁿ⁺¹:

$$\begin{matrix}\frac{{W}^{n + 1} - {W}^{n}}{Δ t} = - \frac{\partial }{\partial x} \{ \frac{{( {h}^{n + 1} )}^{2} {W}^{n + 1}}{3 {C}_{a}} \frac{{\partial }^{3} {h}^{n + 1}}{\partial {x}^{3}} + {U}_{o} {W}^{n} \} + \frac{1}{{S}_{c}} \frac{\partial }{\partial x} ( {h}^{n + 1} D \frac{\partial ( {W}^{n + 1} / {h}^{n + 1} )}{\partial x} ) \\ {W}^{n + 1} + Δ {tN}^{n + 1} {W}^{n + 1} = {W}^{n} - Δ t [ \frac{\partial }{\partial x} ( {U}_{o} {W}^{n} ) ] = {\tilde{W}}^{n} \\ where & ( II \text{-} 17 ) \\ {N}^{n + 1} {W}^{n + 1} = \frac{\partial }{\partial x} \{ {〈 v 〉}^{n + 1} {W}^{n + 1} \} - \frac{1}{{S}_{c}} \frac{\partial }{\partial x} \{ {h}^{n + 1} D \frac{\partial ( {W}^{n + 1} / {h}^{n + 1} )}{\partial x} \} \\ 〈 v 〉 = \frac{{( {h}^{n + 1} )}^{2}}{3 {C}_{a}} \frac{{\partial }^{3} {h}^{n + 1}}{\partial {r}^{3}} & ( II \text{-} 18 )\end{matrix}$$

Again, the advection term in Eq. (II-18) is discretized by using upwind scheme,

$$\frac{\partial }{\partial x} \{ {〈 v 〉}^{n + 1} {W}^{n + 1} \} {\vert}_{i} = \frac{( {〈 v 〉}_{i + 1 / 2}^{n + 1} {W}_{i + 1 / 2}^{n + 1} - {〈 v 〉}_{i - 1 / 2}^{n + 1} {W}_{i - 1 / 2}^{n + 1} )}{Δ x} \\ if ( {〈 v 〉}_{i + 1 / 2}^{n + 1} > 0 ) {W}_{i + 1 / 2}^{n + 1} = {W}_{i}^{n + 1} \\ if ( {〈 v 〉}_{i + 1 / 2}^{n + 1} \leq 0 ) {W}_{i + 1 / 2}^{n + 1} = {W}_{i + 1}^{n + 1} \\ if ( {〈 v 〉}_{i - 1 / 2}^{n + 1} > 0 ) {W}_{i - 1 / 2}^{n + 1} = {W}_{i - 1}^{n + 1} \\ if ( {〈 v 〉}_{i - 1 / 2}^{n + 1} \leq 0 ) {W}_{i - 1 / 2}^{n + 1} = {W}_{i}^{n + 1} \qquad ( II \text{-} 19 )$$

For the last element, i=N, <v>_{i+1/2}ⁿ⁺W_{i+1/2}ⁿ⁺¹=0 due to boundary condition:

$$\frac{\partial }{\partial x} \{ {〈 v 〉}^{n + 1} {W}^{n + 1} \} {\vert}_{last element} = \frac{( - {〈 v 〉}_{i - 1 / 2}^{n + 1} {W}_{i - 1 / 2}^{n + 1} )}{( 1 - α ) Δ x} \qquad ( II \text{-} 20 )$$

Similarly, the right hand side (RHS) term may be discretized with upwind scheme as:

$$\frac{\partial }{\partial x} \{ {U}_{o} {W}^{n} \} {\vert}_{i} = \frac{( {U}_{o} {\vert}_{i + 1 / 2} {W}_{i + 1 / 2}^{n} - {U}_{o} {\vert}_{i - 1 / 2} {W}_{i - 1 / 2}^{n} )}{Δ x} \\ if ( {U}_{o} {\vert}_{i + 1 / 2} > 0 ) {W}_{i + 1 / 2}^{n} = {W}_{i}^{n} \\ if ( {U}_{o} {\vert}_{i + 1 / 2} \leq 0 ) {W}_{i + 1 / 2}^{n} = {W}_{i + 1}^{n} \\ if ( {U}_{o} {\vert}_{i - 1 / 2} > 0 ) {W}_{i - 1 / 2}^{n} = {W}_{i - 1}^{n} \\ if ( {U}_{o} {\vert}_{i - 1 / 2} \leq 0 ) {W}_{i - 1 / 2}^{n} = {W}_{i}^{n} \qquad ( II \text{-} 21 )$$

In embodiments, for the last element of the mesh, a special flux is added at the contact line when it is moving:

$$\begin{matrix}\frac{\partial }{\partial x} \{ {U}_{o} {W}^{n} \} {\vert}_{last element} = \frac{( {U}_{o} {\vert}_{i + 1 / 2} {W}_{i + 1 / 2}^{n} - {U}_{o} {\vert}_{i - 1 / 2} {W}_{i - 1 / 2}^{n} )}{( 1 - α ) Δ x} \\ {U}_{o} {\vert}_{i + 1 / 2} {W}_{i + 1 / 2}^{n} = {( {U}_{o} {W}^{n} )}_{x = {x}_{c}} = {( {U}_{o} ( \frac{1}{2} {h}^{n} {C}^{n} ) )}_{x = {x}_{c}} \\ Therefore , & ( II \text{-} 22 ) \\ \frac{( {U}_{o} {\vert}_{i + 1 / 2} {W}_{i + 1 / 2}^{n} - {U}_{o} {\vert}_{i - 1 / 2} {W}_{i - 1 / 2}^{n} )}{( 1 - α ) Δ r} = \frac{( {( {U}_{o} {W}_{i}^{n} )}_{r = {r}_{c}} - {U}_{o} {\vert}_{i - 1 / 2} {W}_{i - 1 / 2}^{n} )}{( 1 - α ) Δ r} = \frac{( {( {U}_{o} ( \frac{1}{2} {h}^{n} {C}^{n} ) )}_{r = {r}_{c}} - {U}_{o} {\vert}_{i - 1 / 2} {W}_{i - 1 / 2}^{n} )}{( 1 - α ) Δ r} & ( II \text{-} 23 )\end{matrix}$$

The diffusion term in Eq. (II-18) may be discretized:

$$\begin{matrix}\begin{matrix} \frac{1}{{S}_{c}} \frac{\partial }{\partial x} \{ {h}^{n + 1} D \frac{\partial ( {W}^{n + 1} / {h}^{n + 1} )}{\partial x} \} {\vert}_{i} = \frac{1}{{S}_{c}} \frac{\partial V}{\partial x} {\vert}_{i} \\ = \frac{1}{{S}_{c}} \frac{( {V}_{i + \frac{1}{2}} - {V}_{i - \frac{1}{2}} )}{Δ x}\end{matrix} \\ V = {h}^{n + 1} D \frac{\partial ( {W}^{n + 1} / {h}^{n + 1} )}{\partial x} & ( II \text{-} 24 ) \\ {V}_{i + \frac{1}{2}} = ( \frac{{h}^{n + 1} {\vert}_{i} + {h}^{n + 1} {\vert}_{i + 1}}{2} ) {D}_{i + \frac{1}{2}} ( \frac{{W}^{n + 1} / {h}^{n + 1} {\vert}_{i + 1} - {W}^{n + 1} / {h}^{n + 1} {\vert}_{i}}{Δ x} ) \\ {V}_{i - \frac{1}{2}} = ( \frac{{h}^{n + 1} {\vert}_{i} + {h}^{n + 1} {\vert}_{i - 1}}{2} ) {D}_{i - \frac{1}{2}} ( \frac{{W}^{n + 1} / {h}^{n + 1} {\vert}_{i} - {W}^{n + 1} / {h}^{n + 1} {\vert}_{i - 1}}{Δ x} ) & ( II \text{-} 25 )\end{matrix}$$

For the last element, using boundary condition:

$$\frac{1}{{S}_{c}} \frac{\partial V}{\partial x} {\vert}_{last element} = \frac{- {V}_{i - \frac{1}{2}}}{{S}_{c} ( 1 - α ) Δ x} = \frac{- 1}{{S}_{c} ( 1 - α ) Δ {x}^{2}} ( \frac{{h}_{i}^{n + 1} + {h}_{i - 1}^{n + 1}}{2} ) {D}_{i - \frac{1}{2}} ( \frac{{W}_{i}^{n + 1}}{{h}_{i}^{n + 1}} - \frac{{W}_{i - 1}^{n + 1}}{{h}_{i - 1}^{n + 1}} )$$

### E. Methods for Simulating Droplet Solute Concentration

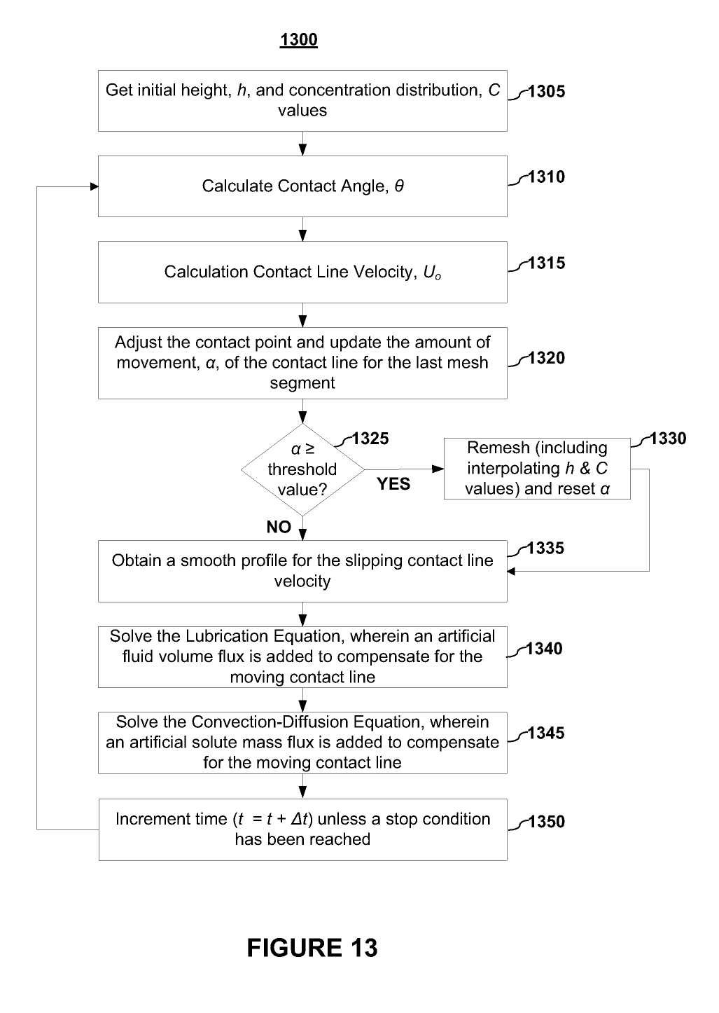

FIG. 13 depicts methods for simulating the solute concentration of evaporating droplet according to embodiments of the present invention. As depicted in FIG. 13, in embodiments, the initial height profile, h, and the initial concentration distribution, C, of the droplet may be used to obtain or set (1305) the discretized height and concentration values. One skilled in the art shall recognize that the height profile/values and/or the concentration distribution/values may be obtained from experimental data. The contact angle, θ, is calculated (1310). One skilled in the art shall recognize that the contact angle, θ, may be calculated using geometry or also obtained from experimental data.

Given the contact angle, θ, the contact line velocity, Uₒ, of the slipping contact line is calculated (1315). In embodiments, as previously noted, the contact line velocity may be determined using Hoffman's model, although other methods may be employed.

The contact point for the droplet is adjusted (1320) based upon the slipping velocity and the time step. The amount that the contact line has slipped or moved, α, in the last mesh element is also updated (1320). It shall be noted that if the contact line velocity, Uₒ, is zero, there will be no adjustment to the contact point or to the decimal percent amount of movement, α.

At step 1325, the amount of movement, α, is checked to determine if it is greater than or equal to a threshold amount. If it is greater than or equal to a threshold amount, the domain is remeshed (1330). In embodiments, α may be set to 0.25, but other values may be selected. One skilled in the art shall recognize that the condition can be set at just greater than (rather than greater than or equal to) a threshold by adjusting the threshold level. In embodiments, remeshing involves re-discretizing the domain into cells and interpolating the height values and solute concentration values of the droplet at the remeshed cell centers. In embodiments, the cells may be remeshed into uniform cells, although other configurations may be used. When the domain is remeshed, the contact line of the droplet will be at the end of the domain; therefore, the amount of movement, α, is set (1330) to zero to reflect this change.

If the amount of movement, α, is not greater than or equal to a threshold amount, a smooth profile, such as one depicted in FIG. 8 in the prior section, is obtain (1335) for the slipping contact line. The lubrication equation is solved (1340), wherein an artificial fluid flux is added to compensate for the moving contact line.

Having solved the lubrication equation to obtain hⁿ⁺¹ at tⁿ⁺¹=tⁿ+Δt, where Δt is the time step, that solution is used in solving (1345) the convection/diffusion equation. Similar to the lubrication equation, when the contact line is adjusted at step 1320, a portion of the droplet volume is lost. To compensate for the lost solute, a solute mass flux is added when solving the convection/diffusion equation.

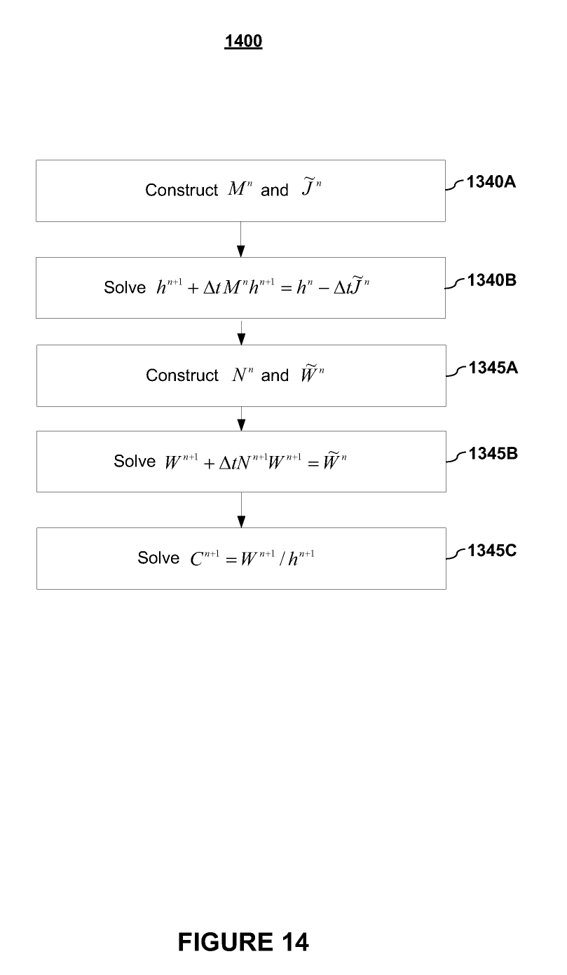

FIG. 14 depicts a method of obtain the solute concentration according to embodiments of the present invention. As previously explained above, the lubrication equation can be solved by constructing Mⁿ and \tilde{J}ⁿ (1340A) and solving (1340B) Equation (14) or (22), which is reproduced below:

hⁿ⁺¹+ΔtMⁿhⁿ⁺¹=hⁿ−Δt\tilde{J}ⁿ

As depicted in FIG. 14, at step 1345A, the matrices Nⁿ and \tilde{W}ⁿ are constructed. and used in solving (1345B) Equation (II-4) or (II-17), which is reproduced below:

Wⁿ⁺¹+ΔtNⁿ⁺¹Wⁿ⁺¹=\tilde{W}ⁿ

Given hⁿ⁺¹ and Wⁿ⁺¹, the solute concentration Cⁿ⁺¹ can be calculated (1345C) from Wⁿ⁺¹/hⁿ⁺¹.

Unless a stop condition has been reached (1350), the time step is incremented (1350) and the process iterates by returning to step 1310. In embodiments, the stop conditions may be one or more of the stop condition previously mentioned and may also include one or more stop conditions related to the solute concentration level.

### F. Numerical Results

Presented below are some examples of droplet concentration simulations according to embodiments of the present invention. In the following numerical example, an axisymmetric droplet is considered with initial height hₒ=18.725 (μm), initial width Rₒ=63.496 (μm), surface tension coefficient σ=0.0365 (N/m), and initial evaporation rate Jₒ=2.0e−11 (m/s). The time step used in the simulation is Δt=0.005852 (sec).

It is assumed that the liquid becomes a gel when the solute concentration C reaches a certain value C_{g} called the gelation concentration. Therefore, the viscosity of the fluid is modeled as μ=μₒ(1+η), where

$$η = \frac{1}{1 - {( \frac{C}{{C}_{g}} )}^{n}} - 1$$

and n=100 reflecting the rapid change in the viscosity as C approaches C_{g}, and μₒ is initial viscosity μₒ=0.00485 (Pa sec). The evaporation is modeled by

$$J = {J}_{o} ( 1 - \frac{C}{{C}_{g}} )$$

so that the evaporation slows to stop as the liquid solidifies. The diffusion coefficient D is also dependent the viscosity as written in D=1/(μₒ(1η)).

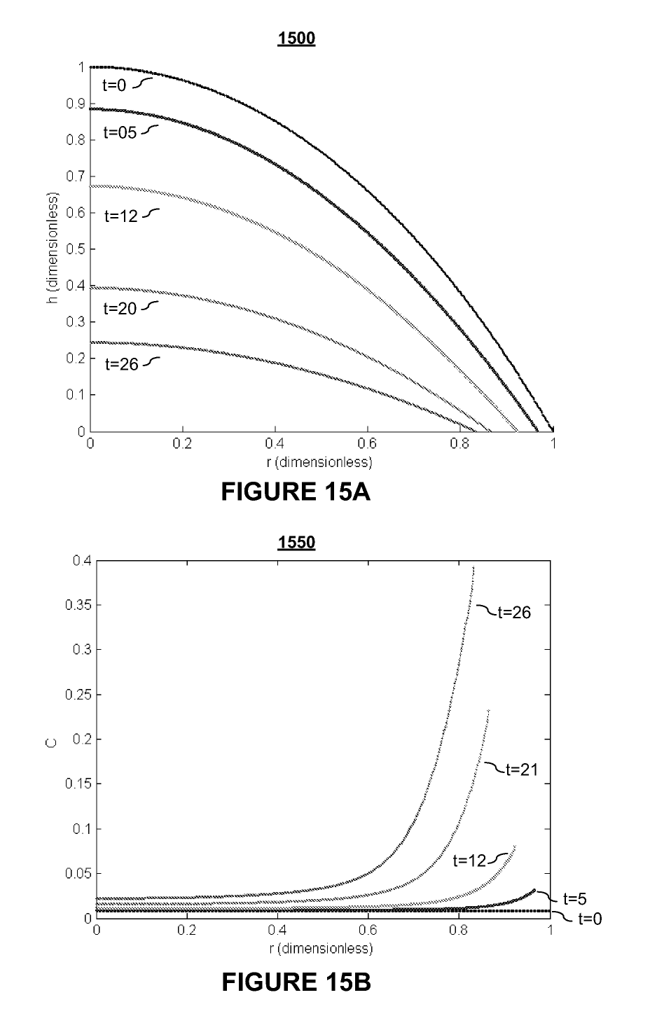

The first example is a case of constant slipping velocity, where Uₒ=0.4069 μm/s. Both lubrication and solute equations are solved for 26 seconds and the change in the droplet height and solute concentration in dimensionless form are plotted in FIG. 15A and FIG. 15B, respectively. FIG. 15A depicts the droplet height, h, at various time increments according to embodiments of the present invention. FIG. 15B depicts the droplet concentration, C, at various time increments according to embodiments of the present invention. During the 26 second time period, a total of 282 remeshings were performed.

Note that the solute mass was also well conserved. The initial solute mass at t=0 was 0.002057984, and the solute mass at t=26 seconds was 0.002053928.

### III. Droplet Evaporation Simulation with Slipping Contact Line and Substrate Geometry

In the first section, numerical methods based on the finite difference method and the Arbitrary Lagrangian Eulerian method (ALE) were presented to solve the fourth-order lubrication equation with slipping contact dynamics. In the second section, the methods were extended to include solving the solute convection/diffusion equation with slipping contact dynamics. In those sections, the simulations of the droplet were on a flat substrate.

In this section, these methods are further extended to address cases with non-flat or non-planar substrate. Presented below, the fourth-order lubrication equation and the second-order solute convection/diffusion equation are rederived so that both the slipping contact line dynamics and the substrate geometry are considered. The finite difference ALE algorithm is modified to solve the new equations. At the end of this section, a numerical example is given to show the capability of the methodologies on simulating the evaporation of an ink droplet and deposit shape on a non-flat substrate.

### A. Special Treatment of Non-Flat Substrate Geometry with Slipping Contact Line Dynamics

In embodiments, to implement a slip condition at the edge of a droplet, an Arbitrary Lagrangian Eulerian (ALE) scheme was introduced. In embodiments, only the last discretized element of the mesh or grid that reflects the change due to the slipping condition is used while uniformly discretized elements are kept for other part of numerical domain.

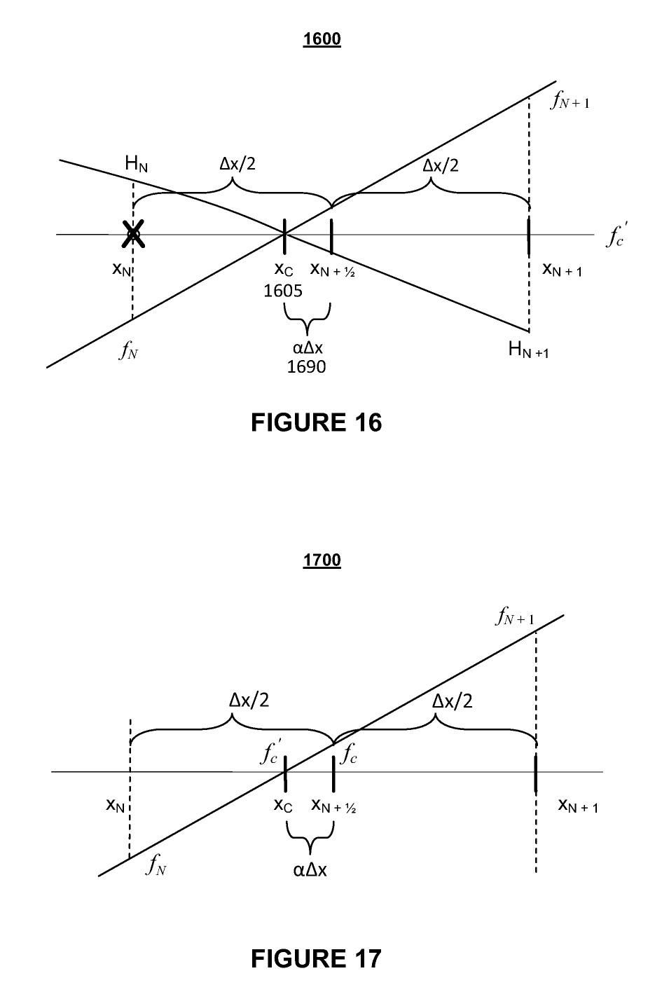

FIG. 16 illustrates an embodiment of the special discretization for the last element to handle a special boundary condition, (H−f)=0, for a non-planar substrate according to embodiments of the present invention. As depicted in FIG. 16, once the slipping contact line moves, x_{c} 1605, the subsequent change of size of the last element can be written as αΔX 1610, where ΔX is the original element size and α is a parameter represents a moving contact line. In embodiments, the geometric constraints to reflect boundary condition can be expressed in the following equations and are applied to solving lubrication equation and solute equation as provided in more detail below.

FIG. 17 represents an approximation of f_{c}′ according to embodiments of the present invention. From the geometric relationships found in FIG. 16 and FIG. 17:

$$\frac{{H}_{N} - {f}_{c}^{′}}{( \frac{1}{2} - α ) Δ x} = \frac{{f}_{c}^{′} - {H}_{N + 1}}{( \frac{1}{2} + α ) Δ x} and \frac{{f}_{c} - {f}_{N}}{Δ x / 2} = \frac{{f}_{c}^{′} - {f}_{N}}{( 1 / 2 - α ) Δ x} \\ Therefore , \\ {H}_{N + 1} = \frac{2}{( 1 - 2 α )} {f}_{c}^{′} - \frac{( 1 + 2 α )}{( 1 - 2 α )} {H}_{N} \\ where \\ {f}_{c}^{′} = {f}_{N} + ( 1 / 2 - α ) ( {f}_{N} - {f}_{N - 1} ) \qquad ( III \text{-} 1 )$$

### B. Axisymmetric Governing Equations with Substrate Geometry

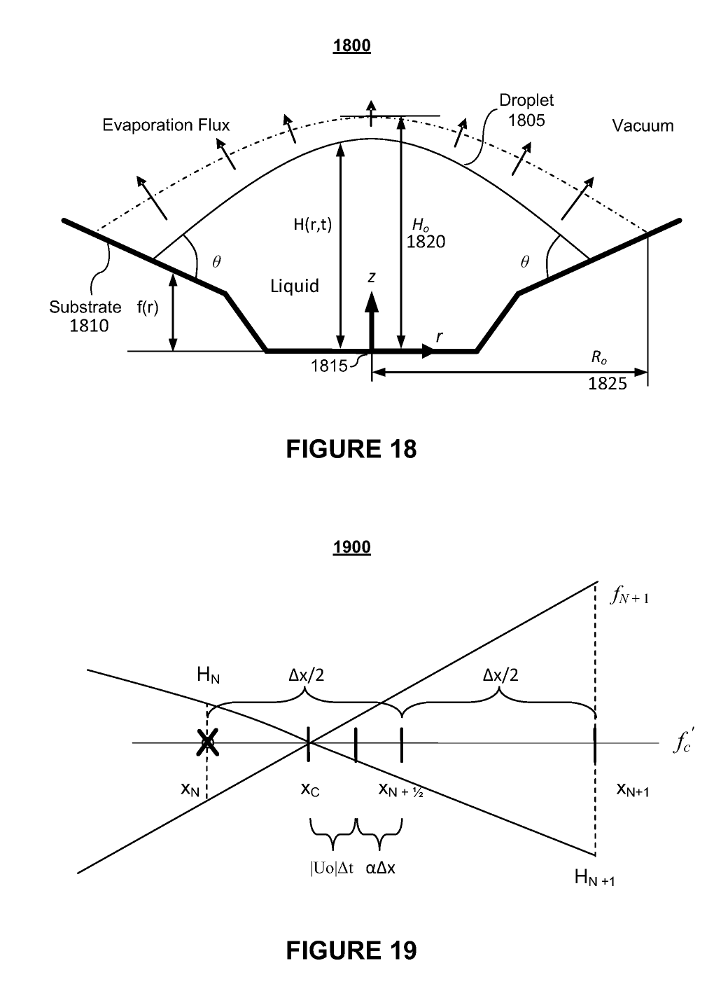

Turning now to FIG. 18, depicted is a droplet 1805 on a non-planar substrate 1810 according to embodiments of the present invention. The size of the droplet 1805 on the substrate 1810 becomes smaller as liquid continues to evaporate over time; that is, the edge of the droplet 1805 moves along the non-flat substrate surface toward the center 1815. The basic governing equations to describe the phenomenon were presented in the previous sections. In these embodiments, it is assumed that the droplet shape is axisymmetric and the axisymmetric coordinate, (r, θ, z), with the origin located at the center 1815 of the bottom circle of the droplet and that the droplet is thin, Hₒ<<Rₒ, where Hₒ 1820 is the initial height and Rₒ 1825 is the initial radius of the droplet. Non-flat substrate surface for the axisymmetric case can be expressed as f(r) 1810 as shown in FIG. 18.

With geometric considerations, the lubrication equation to be solved can be written as follows:

$$\begin{matrix}\frac{\partial H}{\partial t} = - \frac{1}{r} \frac{\partial }{\partial r} [ r ( H - f ) 〈 u 〉 ] - J \\ = - \frac{1}{r} \frac{\partial }{\partial r} [ \frac{{r ( H - f )}^{3}}{3 {C}_{a}} \frac{\partial }{\partial r} \{ \frac{1}{r} \frac{\partial }{\partial r} ( r \frac{\partial H}{\partial r} ) \} + r ( H - f ) {U}_{o} ] - J\end{matrix} \qquad ( III \text{-} 2 )$$

with the following boundary conditions:

$$\begin{matrix}r = 0 \\ \frac{\partial H}{\partial r} = 0 \\ and \\ 〈 u 〉 = 0 & ( III \text{-} 3 ) \\ r = {r}_{c} \\ ( H - f ) = 0 \\ and \\ ( H - f ) 〈 u 〉 = 0 & ( III \text{-} 4 )\end{matrix}$$

where r_{c} represents the moving contact line.

The solute equation can be written as follows:

$$\frac{\partial ( HC )}{\partial t} = - \frac{1}{r} \frac{\partial }{\partial r} [ r ( H - f ) 〈 u 〉 C ] + \frac{1}{{S}_{c}} \frac{1}{r} \frac{\partial }{\partial r} ( r ( H - f ) D \frac{\partial C ) )}{\partial r} ) = - \frac{1}{r} \frac{\partial }{\partial r} [ \frac{{r ( H - f )}^{2} W}{3 {C}_{a}} \frac{\partial }{\partial r} \{ \frac{1}{r} \frac{\partial }{\partial r} ( r \frac{\partial H}{\partial r} ) \} + {rU}_{o} W ] + \frac{1}{{S}_{c}} \frac{1}{r} \frac{\partial }{\partial r} \{ r ( H - f ) D \frac{\partial ( W / ( H - f ) )}{\partial r} \} \qquad ( III \text{-} 5 )$$

where W=(H−f)C with the following boundary conditions:

$$\begin{matrix}\begin{matrix}r = 0 & \begin{matrix}\frac{\partial H}{\partial r} = 0 , & 〈 u 〉 = 0 and \frac{\partial ( W / ( H - f ) )}{\partial r} = 0\end{matrix}\end{matrix} & ( III \text{-} 6 ) \\ \begin{matrix}r = {r}_{c} & \begin{matrix}( H - f ) = 0 , & W 〈 u 〉 = 0 and\end{matrix}\end{matrix} \\ D ( H - f ) \frac{\partial ( W / ( H - f ) )}{\partial r} = 0 & ( III \text{-} 7 ) \\ 〈 u 〉 = \frac{{( H - f )}^{2}}{3 {C}_{a}} \frac{\partial }{\partial r} \{ \frac{1}{r} \frac{\partial }{\partial r} \{ r \frac{\partial H}{\partial r} \} \} + {U}_{o} & ( III \text{-} 8 )\end{matrix}$$

For discretized lubrication equation,

$$\begin{matrix}{H}^{n + 1} + Δ t [ \frac{1}{r} \frac{\partial }{\partial r} ( \frac{{r ( {H}^{n} - f )}^{3}}{3 {C}_{a}} \frac{\partial }{\partial r} ( \frac{1}{r} \frac{\partial {H}^{n + 1}}{\partial r} + \frac{{\partial }^{2} {H}^{n + 1}}{\partial {r}^{2}} ) ) ] = {H}^{n} - Δ t [ {J}^{n} + \frac{1}{r} \frac{\partial }{\partial r} ( r ( {H}^{n} - f ) {U}_{o} ) ] \\ {H}^{n + 1} + Δ {tM}^{n} {H}^{n + 1} = {H}^{n} - Δ t [ {J}^{n} + \frac{1}{r} \frac{\partial }{\partial r} ( r ( {H}^{n} - f ) {U}_{o} ) ] & ( III \text{-} 9 ) \\ \begin{matrix}{M}^{n} {H}^{n + 1} = \frac{1}{r} \frac{\partial }{\partial r} ( \frac{{r ( {H}^{n} - f )}^{3}}{3 {C}_{a} ( 1 + {η}_{sp} )} \frac{\partial }{\partial r} ( \frac{1}{r} \frac{\partial {H}^{n + 1}}{\partial r} + \frac{{\partial }^{2} {H}^{n + 1}}{\partial {r}^{2}} ) ) \\ = \frac{1}{r} \frac{\partial V}{\partial r} \\ = \frac{1}{r} \frac{1}{Δ r} ( {V}_{i + \frac{1}{2}} - {V}_{i - \frac{1}{2}} )\end{matrix} & ( III \text{-} 10 )\end{matrix}$$

For i=N,

$${M}^{n} {H}^{n + 1} = \frac{1}{{r}_{N}} \frac{1}{{r}_{N} ( 1 - α ) Δ r} ( - {V}_{N - \frac{1}{2}} )$$

due to the boundary conditions applied.

$$\begin{matrix}{V}_{N - \frac{1}{2}} = \frac{{r ( {H}^{n} - f )}^{3}}{3 {C}_{a}} \frac{\partial }{\partial r} ( \frac{1}{r} \frac{\partial {H}^{n + 1}}{\partial r} + \frac{{\partial }^{2} {H}^{n + 1}}{\partial {r}^{2}} ) {\vert}_{r = {r}_{N - \frac{1}{2}}} \\ = \frac{{{r}_{N - \frac{1}{2}} ( {H}^{n} - f )}_{N - \frac{1}{2}}^{3}}{3 {C}_{a}} \frac{1}{Δ r} ( {W}_{N} - {W}_{N - 1} ) \\ = \frac{{( coeff . )}_{N - \frac{1}{2}}}{Δ r} ( {Y}_{N} - {Y}_{N - 1} )\end{matrix}$$

$${( coeff . )}_{N - \frac{1}{2}} = \frac{{{r}_{N - \frac{1}{2}} ( {H}^{n} - f )}_{N - \frac{1}{2}}^{3}}{3 {C}_{a}} , \\ {( {H}^{n} - f )}_{N - \frac{1}{2}}^{3} = ( \frac{( {H}^{n} - f ) {\vert}_{N} + ( {H}^{n} - f ) {\vert}_{N - 1 }}{2} )$$

$$\begin{matrix}{Y}_{N} = \frac{1}{{r}_{N}} \frac{( {H}_{N + 1}^{n + 1} - {H}_{N - 1}^{n + 1} )}{2 Δ r} + \frac{( {H}_{N + 1}^{n + 1} - 2 {H}_{N}^{n + 1} + {H}_{N - 1}^{n + 1} )}{( 1 - α ) Δ {r}^{2}} \\ = ( \frac{1}{{r}_{N}} \frac{1}{2 Δ r} + \frac{1}{( 1 - α ) Δ {r}^{2}} ) \frac{2 {f}_{c}^{′}}{( 1 - 2 α )} + \\ \frac{1}{{r}_{N}} ( \frac{- ( 1 + 2 α )}{( 1 - 2 α )} \frac{{H}_{N}^{n + 1}}{2 Δ r} - \frac{{H}_{N - 1}^{n + 1}}{2 Δ r} ) + \\ \frac{1}{( 1 - α ) Δ {r}^{2}} ( \frac{- 3 + 2 α}{( 1 - 2 α )} {H}_{N}^{n + 1} + {H}_{N - 1}^{n + 1} )\end{matrix}$$

$${Y}_{N - 1} = \frac{1}{{r}_{N - 1}} \frac{( {H}_{N}^{n + 1} - {H}_{N - 2}^{n + 1} )}{2 Δ r} + \frac{( {H}_{N}^{n + 1} - 2 {H}_{N - 1}^{n + 1} + {H}_{N - 2}^{n + 1} )}{Δ {r}^{2}}$$

$$Therefore , \\ {Y}_{N} - {Y}_{N - 1} = ( \frac{1}{{r}_{N}} \frac{1}{2 Δ r} + \frac{1}{( 1 - α ) Δ {r}^{2}} ) \frac{2 {f}_{c}^{′}}{( 1 - 2 α )} + ( \frac{1}{{r}_{N}} ( \frac{- ( 1 + 2 α )}{( 1 - 2 α )} \frac{1}{2 Δ r} ) + \frac{1}{( 1 - α ) Δ {r}^{2}} ( \frac{- 3 + 2 α}{( 1 - 2 α )} ) - \frac{1}{{r}_{N - 1}} \frac{1}{2 Δ r} - \frac{1}{Δ {r}^{2}} ) {H}_{N}^{n + 1} + ( \frac{1}{{r}_{N}} ( - \frac{1}{2 Δ r} ) + \frac{1}{( 1 - α ) Δ {r}^{2}} + \frac{2}{Δ {r}^{2}} ) {H}_{N - 1}^{n + 1} + ( \frac{1}{{r}_{N - 1}} \frac{1}{2 Δ r} - \frac{1}{Δ {r}^{2}} ) {H}_{N - 2}^{n + 1}$$

$${Y}_{N} - {Y}_{N - 1} = ( \frac{1}{{r}_{N}} \frac{1}{2 Δ r} + \frac{1}{( 1 - α ) Δ {r}^{2}} ) \frac{2 {f}_{c}^{′}}{( 1 - 2 α )} + {( coeff . )}_{N} {H}_{N}^{n + 1} + {( coeff . )}_{N - 1} {H}_{N - 1}^{n + 1} + {( coeff . )}_{N - 2} {H}_{N - 2}^{n + 1}$$

$$\begin{matrix}{V}_{N - \frac{1}{2}} = \frac{{( coeff . )}_{N - \frac{1}{2}}}{Δ r} ( {Y}_{N} - {Y}_{N - 1} ) \\ = \frac{{( coef . )}_{N - \frac{1}{2}}}{Δ r} ( ( \frac{1}{{r}_{N}} \frac{1}{2 Δ r} + \frac{1}{( 1 - α ) Δ {r}^{2}} ) \frac{2 {f}_{c}^{′}}{( 1 - 2 α )} + \\ {( coeff . )}_{N} {H}_{N}^{n + 1} + {( coeff . )}_{N - 1} {H}_{N - 1}^{n + 1} + {( coeff . )}_{N - 2} {H}_{N - 2}^{n + 1} )\end{matrix}$$

In summary, for i=N,

$${H}^{n + 1} + Δ t \frac{1}{{r}_{N}} \frac{1}{( 1 - α ) Δ r} ( \frac{- {( coef . )}_{N - \frac{1}{2}}}{Δ r} ( {( coeff . )}_{N} {H}_{N}^{n + 1} + {( coeff . )}_{N - 1} {H}_{N - 1}^{n + 1} + {( coeff . )}_{N - 2} {H}_{N - 2}^{n + 1} ) ) = {H}^{n} - Δ t [ {J}^{n} + \frac{1}{r} \frac{\partial }{\partial r} ( r ( {H}^{n} - f ) {U}_{o} ) + \frac{1}{{r}_{N}} \frac{1}{( 1 - α ) Δ r} ( \frac{- {( coef . )}_{N - \frac{1}{2}}}{Δ r} ( ( \frac{1}{{r}_{N}} \frac{1}{2 Δ r} + \frac{1}{( 1 - α ) Δ {r}^{2}} ) \frac{2 {f}_{c}^{′}}{( 1 - 2 α )} ) ) ] \qquad ( III \text{-} 11 )$$

One skilled in the art shall recognize that the left hand side is identical to the ones found in previously derived equations for the case without geometric considerations of the substrate. Therefore, the right hand side terms can be updated fairly conveniently from previous implementations.

For i=N−1,

$${M}^{n} {H}^{n + 1} = \frac{1}{{r}_{N - 1}} \frac{1}{Δ r} ( {V}_{N - \frac{1}{2}} - {V}_{N - \frac{3}{2}} )$$

$$\begin{matrix}{V}_{N - \frac{3}{2}} = \frac{{r ( {H}^{n} - f )}^{3}}{3 {C}_{a}} \frac{\partial }{\partial r} ( \frac{1}{r} \frac{\partial {H}^{n + 1}}{\partial r} + \frac{\partial {H}^{n + 1}}{\partial {r}^{2}} ) {\vert}_{r = {r}_{N - \frac{3}{2}}} \\ = \frac{{{r}_{N - \frac{3}{2}} ( {H}^{n} - f )}_{N - \frac{3}{2}}^{3}}{3 {C}_{a}} \frac{1}{Δ r} ( {Y}_{N - 1} - {Y}_{N - 2} ) \\ = \frac{{( coeff . )}_{N - \frac{3}{2}}}{Δ r} ( {Y}_{N - 1} - {Y}_{N - 2} )\end{matrix}$$

$${( coeff . )}_{N - \frac{1}{2}} = \frac{{{r}_{N - \frac{1}{2}} ( {H}^{n} - f )}_{N - \frac{1}{2}}^{3}}{3 {C}_{a}} , \\ {( {H}^{n} - f )}_{N - \frac{1}{2}}^{3} = ( \frac{( {H}^{n} - f ) {\vert}_{N - 1} + ( {H}^{n} - f ) {\vert}_{N - 2}}{2} )$$

$${Y}_{N - 1} = \frac{1}{{r}_{N - 1}} \frac{( {H}_{N}^{n + 1} - {H}_{N - 2}^{n + 1} )}{2 Δ r} + \frac{( {H}_{N}^{n + 1} - 2 {H}_{N - 1}^{n + 1} + {H}_{N - 2}^{n + 1} )}{Δ {r}^{2}}$$

$${Y}_{N - 2} = \frac{1}{{r}_{N - 2}} \frac{( {H}_{N - 1}^{n + 1} - {H}_{N - 3}^{n + 1} )}{2 Δ r} + \frac{( {H}_{N}^{n + 1} - 2 {H}_{N - 1}^{n + 1} + {H}_{N - 2}^{n + 1} )}{Δ {r}^{2}}$$

$$\begin{matrix}{Y}_{N - 1} - {Y}_{N - 2} = \frac{1}{{r}_{N - 1}} \frac{( {H}_{N}^{n + 1} - {H}_{N - 2}^{n + 1} )}{2 Δ r} + \\ \frac{( {H}_{N}^{n + 1} - 2 {H}_{N - 1}^{n + 1} + {H}_{N - 2}^{n + 1} )}{Δ {r}^{2}} - \\ \frac{1}{{r}_{N - 2}} \frac{( {H}_{N - 1}^{n + 1} - {H}_{N - 3}^{n + 1} )}{2 Δ r} - \\ \frac{( {H}_{N}^{n + 1} - 2 {H}_{N - 1}^{n + 1} + {H}_{N - 3}^{n + 1} )}{Δ {r}^{2}} \\ = \frac{1}{{r}_{N - 1}} \frac{{H}_{N}^{n + 1}}{2 Δ r} - \frac{1}{{r}_{N - 1}} \frac{{H}_{N - 2}^{n + 1}}{2 Δ r} + \frac{{H}_{N}^{n + 1}}{Δ {r}^{2}} - \frac{2 {H}_{N - 1}^{n + 1}}{Δ {r}^{2}} + \\ \frac{{H}_{N - 2}^{n + 1}}{Δ r} - \frac{1}{{r}_{N - 2}} \frac{{H}_{N - 1}^{n + 1}}{2 Δ r} + \frac{1}{{r}_{N - 2}} \frac{{H}_{N - 3}^{n + 1}}{2 Δ r} - \frac{{H}_{N - 1}^{n + 1}}{Δ {r}^{2}} + \\ \frac{2 {H}_{N - 2}^{n + 1}}{Δ {r}^{2}} - \frac{{H}_{N - 3}^{n + 1}}{Δ {r}^{2}} \\ = ( \frac{1}{{r}_{N - 1}} \frac{1}{2 Δ r} + \frac{1}{Δ {r}^{2}} ) {H}_{N}^{n + 1} - \\ ( \frac{1}{{r}_{N - 2}} \frac{1}{2 Δ r} + \frac{3}{Δ {r}^{2}} ) {H}_{N - 1}^{n + 1} - \\ ( \frac{1}{{r}_{N - 1}} \frac{1}{2 Δ r} - \frac{3}{Δ {r}^{2}} ) {H}_{N - 2}^{n + 1} + \\ ( \frac{1}{{r}_{N - 2}} \frac{1}{2 Δ r} - \frac{1}{Δ {r}^{2}} ) {H}_{N - 3}^{n + 1}\end{matrix}$$

$$\begin{matrix}{V}_{N - \frac{3}{2}} = \frac{{( coeff . )}_{N - \frac{3}{2}}}{Δ r} ( ( \frac{1}{{r}_{N - 1}} \frac{1}{2 Δ r} + \frac{1}{Δ {r}^{2}} ) {H}_{N}^{n + 1} - \\ ( \frac{1}{{r}_{N - 2}} \frac{1}{2 Δ r} + \frac{3}{Δ {r}^{2}} ) {H}_{N - 1}^{n + 1} - ( \frac{1}{{r}_{N - 1}} \frac{1}{2 Δ r} - \frac{3}{Δ {r}^{2}} ) {H}_{N - 2}^{n + 1} + \\ ( \frac{1}{{r}_{N - 2}} \frac{1}{2 Δ r} - \frac{1}{Δ {r}^{2}} ) {H}_{N - 3}^{n + 1} ) \\ = \frac{{( coeff . )}_{N - \frac{3}{2}}}{Δ r} ( {( coeff . )}_{N} {H}_{N}^{n + 1} - {( coeff . )}_{N - 1} {H}_{N - 1}^{n + 1} - \\ {( coeff )}_{N - 2} {H}_{N - 2}^{n + 1} + {( coeff . )}_{N - 3} {H}_{N - 3}^{n + 1} )\end{matrix}$$

$${V}_{N - \frac{1}{2}} = \frac{{( coeff . )}_{N - \frac{1}{2}}}{Δ r} ( ( \frac{1}{{r}_{N}} \frac{1}{2 Δ r} + \frac{1}{( 1 - α ) Δ {r}^{2}} ) \frac{2 {f}_{c}^{′}}{( 1 - 2 α )} + {( coeff . )}_{N} {H}_{N}^{n + 1} + {( coeff . )}_{N - 1} {H}_{N - 1}^{n + 1} + {( coeff . )}_{N - 2} {H}_{N - 2}^{n + 1} )$$

Therefore, i=N−1,

$${H}^{n + 1} + Δ t \frac{1}{{r}_{N - 1}} \frac{1}{Δ r} ( {( coeff . )}_{N} {H}_{N}^{n + 1} + {( coeff . )}_{N - 1} {H}_{N - 1}^{n + 1} + {( coeff . )}_{N - 2} {H}_{N - 2}^{n + 1} + {( coeff . )}_{N - 3} {H}_{N - 3}^{n + 1} ) = {H}^{n} - Δ t [ {J}^{n} + \frac{1}{r} \frac{\partial }{\partial r} ( r ( {H}^{n} - f ) {U}_{o} ) + \frac{1}{{r}_{N - 1}} \frac{1}{Δ r} ( \frac{{( coeff . )}_{N - \frac{1}{2}}}{Δ r} ( ( \frac{1}{{r}_{N}} \frac{1}{2 Δ r} + \frac{1}{( 1 - α ) Δ {r}^{2}} ) \frac{2 {f}_{c}^{′}}{( 1 - 2 α )} ) ) ] \qquad ( III \text{-} 12 )$$

FIG. 19 illustrates a special ALE discretization for the last mesh element for axisymmetric embodiments according to embodiments of the present invention.

As shown in the previous sections, in embodiments, a special form is added to reflect continuously changing numerical domain due to slipping contact line. The added term compensates the loss in the mass when the finite difference method is used to discretize the governing equations. To make the proposed numerical algorithm consistent, a similar treatment is applied when complex geometric considerations for slipping contact line are considered.

For right hand side (RHS) term found in the lubrication equation, Eq. (III-9):

$$\frac{1}{r} \frac{\partial }{\partial r} ( r ( {H}^{n} - f ) {U}_{o} ) = \frac{1}{{r}_{i}} \frac{1}{Δ r} ( {Q}_{i + \frac{1}{2}} - {Q}_{i - \frac{1}{2}} ) \qquad ( III \text{-} 13 )$$

For i=N,

$$\frac{1}{{r}_{N}} \frac{1}{( 1 - α ) Δ r} ( {Q}_{N + \frac{1}{2}} - {Q}_{N - \frac{1}{2}} ) = \frac{1}{{r}_{N}} \frac{1}{( 1 - α ) Δ r} ( {Q}_{N + \frac{1}{2}} - {Q}_{N - \frac{1}{2}} ) \\ {Q}_{N + \frac{1}{2}} = r ( {H}^{n} - f ) {U}_{o} {\vert}_{N + \frac{1}{2}} = {r}_{N + \frac{1}{2}} ( \frac{( {H}^{n} - f ) {\vert}_{N} + ( {H}^{n} - f ) {\vert}_{N + 1}}{2} ) {U}_{o} {\vert}_{N + \frac{1}{2}} \qquad ( III \text{-} 14 )$$

The discretized form of the solute equations, Eq. (III-5), may be written as:

$$\begin{matrix} {W}^{n + 1} + Δ {tN}^{n + 1} {W}^{n + 1} = {W}^{n} - Δ t [ \frac{1}{r} \frac{\partial }{\partial r} ( {rU}_{o} {W}^{n} ) ] \\ where \\ {N}^{n + 1} {W}^{n + 1} = \frac{1}{r} \frac{\partial }{\partial r} \{ r < v > {W}^{n + 1} \} - \frac{1}{{S}_{c}} \frac{1}{r} \frac{\partial }{\partial r} ( r ( {H}^{n + 1} - f ) D \frac{\partial ( {W}^{n + 1} / ( {H}^{n + 1} - f ) )}{\partial r} ) & ( III \text{-} 15 ) \\ < v >= \frac{{( {H}^{n + 1} - f )}^{2}}{3 {C}_{a}} \frac{\partial }{\partial r} ( \frac{1}{r} \frac{\partial }{\partial r} \{ r \frac{\partial {H}^{n + 1}}{\partial r} \} ) & ( III \text{-} 16 )\end{matrix}$$

In embodiments, the RHS term in Eq. (III-15) is discretized with upwind scheme as:

$$\frac{1}{r} \frac{\partial }{\partial r} \{ {rU}_{o} {W}^{n} \} = \frac{1}{{r}_{i}} \frac{( {r}_{i + \frac{1}{2}} {U}_{o} {\vert}_{i + \frac{1}{2}} {W}_{i + \frac{1}{2}}^{n} - {r}_{i - \frac{1}{2}} {U}_{o} {\vert}_{i - \frac{1}{2}} {W}_{i - \frac{1}{2}}^{n} )}{Δ r} \\ \begin{matrix}if ( {U}_{o} {\vert}_{i + \frac{1}{2}} > 0 ) & {W}_{i + \frac{1}{2}}^{n} = {W}_{i}^{n} & if ( {U}_{o} {\vert}_{i + \frac{1}{2}} \leq 0 ) & {W}_{i + \frac{1}{2}}^{n} = {W}_{i + 1}^{n} \\ if ( {U}_{o} {\vert}_{i - \frac{1}{2}} > 0 ) & {W}_{i - \frac{1}{2}}^{n} = {W}_{i - 1}^{n} & if ( {U}_{o} {\vert}_{i - \frac{1}{2}} \leq 0 ) & {W}_{i - \frac{1}{2}}^{n} = {W}_{i}^{n}\end{matrix} \qquad ( III \text{-} 17 )$$

For i=N, a special treatment due to upwind scheme for the last element using ALE may be applied:

$${r}_{N + \frac{1}{2}} {U}_{o} {\vert}_{N + \frac{1}{2}} {W}_{N + \frac{1}{2}}^{n} = {( {rU}_{o} \frac{1}{2} {W}_{N}^{n} )}_{r = {r}_{c}} = {( {rU}_{o} ( \frac{1}{2} {h}^{n} {C}^{n} ) )}_{r = {r}_{c}}$$

Therefore, a corresponding term for i=N is added to the left hand side as following:

$$\frac{1}{r} \frac{\partial }{\partial r} \{ r < v {>}^{n + 1} {W}^{n + 1} \} = \frac{1}{{r}_{N}} \frac{( {r}_{N + \frac{1}{2}} < v {>}_{N + \frac{1}{2}}^{n + 1} {( \frac{1}{2} {W}^{n} )}_{r = {r}_{c}} - {r}_{N - \frac{1}{2}} < v {>}_{N - \frac{1}{2}}^{n + 1} {W}_{N - \frac{1}{2}}^{n + 1} )}{( 1 - α ) Δ r} \qquad ( III \text{-} 18 )$$

### C. Two-Dimensional Governing Equations with Substrate Geometry

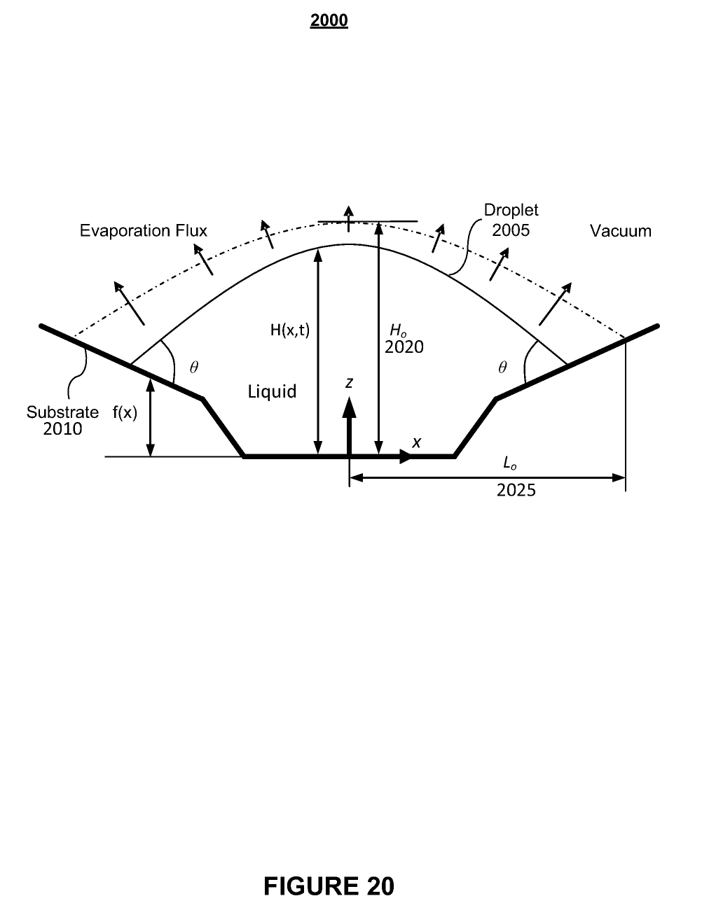

Turning now to FIG. 20, depicted is a droplet 2005 on a non-planar substrate 2010 according to embodiments of the present invention. If the droplet shape does not possess a uniaxial symmetry and one dimension of the structure is much longer than the other, it can be modeled that the variation through the longer dimension is small. Therefore, the above formulation could be further simplified using two-dimensional coordinate (x, z) settings along with non-flat substrate surface in 2D embodiments. As shown in FIG. 20, the height Hₒ 2020 is the initial height and Lₒ 2025 is the initial width of the computational domain, which is half the width of the droplet measured from the center. In embodiments, the lubrication equation with geometric consideration may be written as follows:

$$\begin{matrix}\frac{\partial H}{\partial t} = - \frac{\partial }{\partial x} [ ( H - f ) < u > ] - J \\ = - \frac{\partial }{\partial x} [ \frac{{( H - f )}^{3}}{3 {C}_{a}} \frac{{\partial }^{3} H}{\partial {x}^{3}} + ( H - f ) {U}_{o} ] - J\end{matrix} \qquad ( III \text{-} 19 )$$

with the following boundary conditions:

$$\begin{matrix}\begin{matrix}x = 0 & \frac{\partial H}{\partial r} = 0 and 〈 u 〉 = 0\end{matrix} & ( III \text{-} 20 ) \\ \begin{matrix}x = {x}_{c} & ( H - f ) = 0 and ( H - f ) 〈 u 〉 = 0\end{matrix} & ( III \text{-} 21 )\end{matrix}$$

And the solute equation may be written as:

$$\begin{matrix}\frac{\partial ( HC )}{\partial t} = - \frac{\partial }{\partial x} [ ( H - f ) < u > C ] \frac{1}{{S}_{c}} \frac{\partial }{\partial x} ( ( H - f ) D \frac{\partial C}{\partial x} ) \\ = - \frac{\partial }{\partial x} [ \frac{{( H - f )}^{2} W}{3 {C}_{a}} \frac{{\partial }^{3} H}{\partial {x}^{3}} + {U}_{o} W ] + \\ \frac{1}{{S}_{c}} \frac{\partial }{\partial x} \{ ( H - f ) D \frac{\partial ( W / ( H - f ) )}{\partial x} \}\end{matrix} \qquad ( III \text{-} 22 )$$

where W=(H−f)C with the following boundary conditions:

$$\begin{matrix}\begin{matrix}\begin{matrix}x = 0 & \frac{\partial H}{\partial r} = 0 ,\end{matrix} & 〈 u 〉 = 0 and \frac{\partial ( W / ( H - f ) )}{\partial r} = 0\end{matrix} & ( III \text{-} 23 ) \\ \begin{matrix}x = {x}_{c} & \begin{matrix}( H - f ) = 0 , & W 〈 u 〉 = 0 and\end{matrix}\end{matrix} \\ D ( H - f ) \frac{\partial ( W / ( H - f ) )}{\partial r} = 0 & ( III \text{-} 24 ) \\ 〈 u 〉 = \frac{{( H - f )}^{2}}{3 {C}_{a}} \frac{{\partial }^{3} H}{\partial {x}^{3}} + {U}_{o} & ( III \text{-} 25 )\end{matrix}$$

where x_{c} represent slipping contact line.

A discretized lubrication equation, Eq. (III-19), may be written as:

$$\begin{matrix}{H}^{n + 1} + Δ t [ \frac{\partial }{\partial x} ( \frac{{( {H}^{n} - f )}^{3}}{3 {C}_{a}} \frac{{\partial }^{3} {H}^{n + 1}}{\partial {x}^{3}} ) ] = {H}^{n} - Δ t [ {J}^{n} + \frac{\partial }{\partial x} ( ( {H}^{n} - f ) {U}_{o} ) ] & ( III \text{-} 26 ) \\ {H}^{n + 1} + Δ {tM}^{n} {H}^{n + 1} = {H}^{n} - Δ t [ {J}^{n} + \frac{\partial }{\partial x} ( ( {H}^{n} - f ) {U}_{o} ) ] & ( III \text{-} 27 ) \\ \begin{matrix}{M}^{n} {H}^{n + 1} = \frac{\partial }{\partial x} ( \frac{{( {H}^{n} - f )}^{3}}{3 {C}_{a}} \frac{{\partial }^{3} {H}^{n + 1}}{\partial {x}^{3}} ) \\ = \frac{\partial V}{\partial x} \\ = \frac{1}{Δ x} ( {V}_{i + \frac{1}{2}} - {V}_{i - \frac{1}{2}} )\end{matrix} & ( III \text{-} 28 )\end{matrix}$$

For i=N,

$${M}^{n} {H}^{n + 1} = \frac{1}{( 1 - α ) Δ x} ( - {V}_{N - \frac{1}{2}} )$$

due to boundary conditions applied.

$$\begin{matrix}{V}_{N - \frac{1}{2}} = \frac{{( {H}^{n} - f )}^{3}}{3 {C}_{a}} \frac{{\partial }^{3} {H}^{n + 1}}{\partial {x}^{3}} {\vert}_{r = {r}_{N - \frac{1}{2}}} \\ = \frac{{( {H}^{n} - f )}_{N - \frac{1}{2}}^{3}}{3 {C}_{a}} \frac{1}{Δ x} ( {Y}_{N} - {Y}_{N - 1} ) \\ = \frac{{( coeff . )}_{N - \frac{1}{2}}}{Δ x} ( {Y}_{N} - {Y}_{N - 1} )\end{matrix} \\ {( coeff . )}_{N - \frac{1}{2}} = \frac{{( {H}^{n} - f )}_{N - \frac{1}{2}}^{3}}{3 {C}_{a}} , \\ {( {H}^{n} - f )}_{N - \frac{1}{2}}^{3} = ( \frac{( {H}^{n} - f ) {\vert}_{N} + ( {H}^{n} - f ) {\vert}_{N - 1}}{2} ) \\ \begin{matrix}{Y}_{N} = \frac{1}{( 1 - α ) Δ x} ( {( \frac{\partial {H}^{n + 1}}{\partial x} )}_{N + \frac{1}{2}} - {( \frac{\partial {H}^{n + 1}}{\partial x} )}_{N - \frac{1}{2}} ) \\ = \frac{1}{( 1 - α ) Δ x} ( \frac{{H}_{N + 1}^{n + 1} - {H}_{N}^{n + 1}}{Δ x} - \frac{{H}_{N}^{n + 1} - {H}_{N - 1}^{n + 1}}{Δ x} ) \\ = \frac{1}{( 1 - α ) Δ x} ( ( \frac{2}{( 1 - 2 α )} {f}_{c}^{′} - \frac{( 1 + 2 α )}{( 1 - 2 α )} {H}_{N}^{n + 1} - {H}_{N}^{n + 1} ) - \\ ( {H}_{N}^{n + 1} - {H}_{N - 1}^{n + 1} ) ) \\ = \frac{1}{( 1 - α ) Δ x} ( \frac{2}{( 1 - 2 α )} {f}_{c}^{′} - \frac{- 3 + 2 α}{( 1 - 2 α )} {H}_{N}^{n + 1} + {H}_{N - 1}^{n + 1} )\end{matrix} \\ \begin{matrix}{Y}_{N - 1} = \frac{1}{Δ x} ( {( \frac{{\partial }^{2} {H}^{n + 1}}{\partial {x}^{2}} )}_{N - \frac{1}{2}} - {( \frac{{\partial }^{2} {H}^{n + 1}}{\partial {x}^{2}} )}_{N - \frac{3}{2}} ) \\ = \frac{{H}_{N}^{n + 1} - 2 {H}_{N - 1}^{n + 1} + {H}_{N - 2}^{n + 1}}{Δ {x}^{2}}\end{matrix} \\ {V}_{N - \frac{1}{2}} = \frac{{( coeff . )}_{N - \frac{1}{2}}}{Δ x} ( \begin{matrix}\frac{1}{( 1 - α ) Δ {x}^{2}} \frac{2 {f}_{c}^{′}}{( 1 - 2 α )} + \\ \{ \frac{1}{( 1 - α ) Δ {x}^{2}} ( \frac{- 3 + 2 α}{1 - 2 α} ) - \frac{1}{Δ {x}^{2}} \} {H}_{N}^{n + 1} + \\ \{ \frac{1}{( 1 - α ) Δ {x}^{2}} + \frac{2}{Δ {x}^{2}} \} {H}_{N - 1}^{n + 1} + \frac{1}{Δ {x}^{2}} {H}_{N - 2}^{n + 1}\end{matrix} ) \\ Therefore , \\ {H}^{n + 1} + Δ t \frac{1}{( 1 - α ) Δ x} ( \frac{- {( coeff . )}_{N - \frac{1}{2}}}{Δ x} ( \{ coeff . \} {H}_{N}^{n + 1} + \{ coeff . \} {H}_{N - 1}^{n + 1} + \{ coeff . \} {H}_{N - 2}^{n + 1} ) ) = {H}^{n} - Δ t ( {J}_{N}^{n} + \frac{\partial }{\partial x} ( ( {H}^{n} - f ) {U}_{o} ) + \frac{1}{( 1 - α ) Δ x} \frac{- {( coeff . )}_{N - \frac{1}{2}}}{Δ x} ( \frac{1}{( 1 - α ) Δ {x}^{2}} \frac{2}{( 1 - 2 α )} {f}_{c}^{′} ) ) \qquad ( III \text{-} 29 )$$

For i=N−1,

$${M}^{n} {H}^{n + 1} = \frac{1}{Δ x} ( {V}_{i - \frac{1}{2}} - {V}_{i - \frac{3}{2}} ) \\ {V}_{N - \frac{1}{2}} = \frac{{( coeff . )}_{N - \frac{1}{2}}}{Δ x} ( \{ coeff . \} {H}_{N}^{n + 1} + \{ coeff . \} {H}_{N - 1}^{n + 1} + \{ coeff . \} {H}_{N - 2}^{n + 1} + \frac{1}{( 1 - α ) Δ {x}^{2}} \frac{2}{( 1 - 2 α )} {f}_{c}^{′} ) \\ \begin{matrix}{V}_{N - \frac{3}{2}} = \frac{{( coeff . )}_{N - \frac{3}{2}}}{Δ x} ( {( \frac{{\partial }^{2} {H}^{n + 1}}{\partial {x}^{2}} )}_{N - 1} - {( \frac{{\partial }^{2} {H}^{n + 1}}{\partial {x}^{2}} )}_{N - 2} ) \\ = \frac{{( coeff . )}_{N - \frac{3}{2}}}{Δ x} ( {Y}_{N - 1} - {Y}_{N - 2} )\end{matrix} \\ {Y}_{N - 1} = \frac{{H}_{N}^{n + 1} - 2 {H}_{N - 1}^{n + 1} + {H}_{N - 2}^{n + 1}}{Δ {x}^{2}} \\ {Y}_{N - 2} = \frac{{H}_{N - 1}^{n + 1} - 2 {H}_{N - 2}^{n + 1} + {H}_{N - 3}^{n + 1}}{Δ {x}^{2}} \\ \begin{matrix}{V}_{N - \frac{3}{2}} = \frac{{( coeff . )}_{N - \frac{3}{2}}}{Δ x} \\ ( \frac{{H}_{N}^{n + 1} - 2 {H}_{N - 1}^{n + 1} + {H}_{N - 2}^{n + 1}}{Δ {x}^{2}} - \\ \frac{{H}_{N - 1}^{n + 1} - 2 {H}_{N - 2}^{n + 1} + {H}_{N - 3}^{n + 1}}{Δ {x}^{2}} ) \\ = \frac{{( coeff . )}_{N - \frac{3}{2}}}{Δ x} \\ ( \{ coeff . \} {H}_{N}^{n + 1} + \{ coeff . \} {H}_{N - 1}^{n - 1} + \\ \{ coeff . \} {H}_{N - 2}^{n + 1} + \{ coeff . \} {H}_{N - 3}^{n + 1} )\end{matrix} \\ {H}^{n + 1} + Δ t \frac{1}{Δ x} ( ( \{ coeff . \} {H}_{N}^{n + 1} + \{ coeff . \} {H}_{N - 1}^{n + 1} + \{ coeff . \} {H}_{N - 2}^{n + 1} + \{ coeff . \} {H}_{N - 3}^{n + 1} ) ) = {H}^{n} - Δ t ( {J}_{N}^{n} + \frac{\partial }{\partial x} ( ( {H}^{n} - f ) {U}_{o} ) + \frac{{( coeff . )}_{N - \frac{1}{2}}}{Δ x} ( \frac{1}{( 1 - α ) Δ {x}^{2}} \frac{2}{( 1 - 2 α )} {f}_{c}^{′} ) ) \qquad ( III \text{-} 30 )$$

For the right hand side term found in the lubrication equation, Eq. (III-26):

$$\frac{\partial }{\partial x} ( {H}^{n} - f ) {U}_{o} = \frac{1}{Δ x} ( {Q}_{i + \frac{1}{2}} - {Q}_{i - \frac{1}{2}} ) \qquad ( III \text{-} 31 )$$

For i=N,

$$\frac{\partial }{\partial x} ( {H}^{n} - f ) {U}_{o} = \frac{1}{( 1 - α ) Δ x} ( {Q}_{N + \frac{1}{2}} - {Q}_{N - \frac{1}{2}} )$$

$$\begin{matrix}{Q}_{N - \frac{1}{2}} = ( {H}^{n} - f ) {U}_{o} {\vert}_{N - \frac{1}{2}} \\ = ( \frac{( {H}^{n} - f ) {\vert}_{N} + ( {H}^{n} - f ) {\vert}_{N - 1}}{2} ) {U}_{o} {\vert}_{N - \frac{1}{2}}\end{matrix}$$

$$\begin{matrix}{Q}_{N + \frac{1}{2}} = ( {H}^{n} - f ) {U}_{o} {\vert}_{N + \frac{1}{2}} \\ = ( \frac{( {H}^{n} - f ) {\vert}_{N} + ( {H}^{n} - f ) {\vert}_{N + 1}}{2} ) {U}_{o} {\vert}_{N - \frac{1}{2}}\end{matrix}$$

$$where$$

$$\frac{{H}_{N} - {f}_{c}^{′}}{( \frac{Δ x}{2} - αΔ x - \vert {U}_{c} \vert Δ t )} = \frac{{f}_{c}^{′} - {H}_{N + 1}}{( \frac{Δ x}{2} - αΔ x + \vert {U}_{c} \vert Δ t )}$$

$${H}_{N + 1} = \frac{2 Δ x}{( Δ x - 2 αΔ x - 2 \vert {U}_{c} \vert Δ t )} {f}_{c}^{′} - \frac{( Δ x + 2 αΔ x - 2 \vert {U}_{c} \vert Δ t )}{( Δ x - 2 αΔ x - 2 \vert {U}_{c} \vert Δ t )} {H}_{N}$$

A discretized solute equation, Eq. (III-22), may be written as:

$${W}^{n + 1} + Δ {tN}^{n + 1} {W}^{n + 1} = {W}^{n} - Δ t [ \frac{\partial }{\partial x} ( {U}_{o} {W}^{n} ) ] \\ where \\ {N}^{n + 1} {W}^{n + 1} = \frac{\partial }{\partial x} \{ < v > {W}^{n + 1} \} - \frac{1}{{S}_{c}} \frac{\partial }{\partial x} ( ( {H}^{n + 1} - f ) D \frac{\partial ( {W}^{n + 1} / ( {H}^{n + 1} - f ) )}{\partial x} ) \\ < v >= \frac{{( {H}^{n + 1} - f )}^{2}}{3 {C}_{a}} \frac{{\partial }^{3} {H}^{n + 1}}{\partial {x}^{3}} \qquad ( III \text{-} 32 )$$

And, in embodiments, the right hand side term in Eq. (III-32) is discretized with upwind scheme as:

$$\frac{\partial }{\partial x} \{ {U}_{o} {W}^{n} \} = \frac{( {U}_{o} {\vert}_{i + \frac{1}{2}} {W}_{i + \frac{1}{2}}^{n} - {U}_{o} {\vert}_{i - \frac{1}{2}} {W}_{i - \frac{1}{2}}^{n} )}{Δ x} \\ \begin{matrix}if ( {U}_{o} {\vert}_{i + \frac{1}{2}} > 0 ) & {W}_{i + \frac{1}{2}}^{n} = {W}_{i}^{n} & if ( {U}_{o} {\vert}_{i + \frac{1}{2}} \leq 0 ) & {W}_{i + \frac{1}{2}}^{n} = {W}_{i + 1}^{n} \\ if ( {U}_{o} {\vert}_{i - \frac{1}{2}} > 0 ) & {W}_{i - \frac{1}{2}}^{n} = {W}_{i - 1}^{n} & if ( {U}_{o} {\vert}_{i - \frac{1}{2}} \leq 0 ) & {W}_{i - \frac{1}{2}}^{n} = {W}_{i}^{n}\end{matrix} \qquad ( III \text{-} 33 )$$

For i=N,

$$\frac{\partial }{\partial x} {\{ {U}_{o} {W}^{n} \}}_{N} = \frac{( {U}_{o} {\vert}_{N + \frac{1}{2}} {W}_{N + \frac{1}{2}}^{n} - {U}_{o} {\vert}_{N - \frac{1}{2}} {W}_{N - \frac{1}{2}}^{n} )}{( 1 - α ) Δ x}$$

In embodiments, a special treatment for the last element using ALE:

$${U}_{o} {\vert}_{N + \frac{1}{2}} {W}_{N + \frac{1}{2}}^{n} = {( {U}_{o} {W}^{n} )}_{x = {x}_{c}} = {( {U}_{o} ( \frac{1}{2} {h}^{n} {C}^{n} ) )}_{x = {x}_{c}} \qquad ( III \text{-} 34 )$$

Therefore, a corresponding term for i=N is added to the left hand side as following:

$$\frac{\partial }{\partial x} {\{ < v {>}^{n + 1} {W}^{n + 1} \}}_{N} = \frac{( < v {>}_{N + \frac{1}{2}}^{n + 1} {( \frac{1}{2} {W}_{N}^{n} )}_{r = {r}_{c}} - < v {>}_{N - \frac{1}{2}}^{n + 1} {W}_{N - \frac{1}{2}}^{n + 1} )}{( 1 - α ) Δ x} \qquad ( III \text{-} 35 )$$

### D. Methods for Simulating Droplet with Moving Contact Line and Non-Planar Substrate

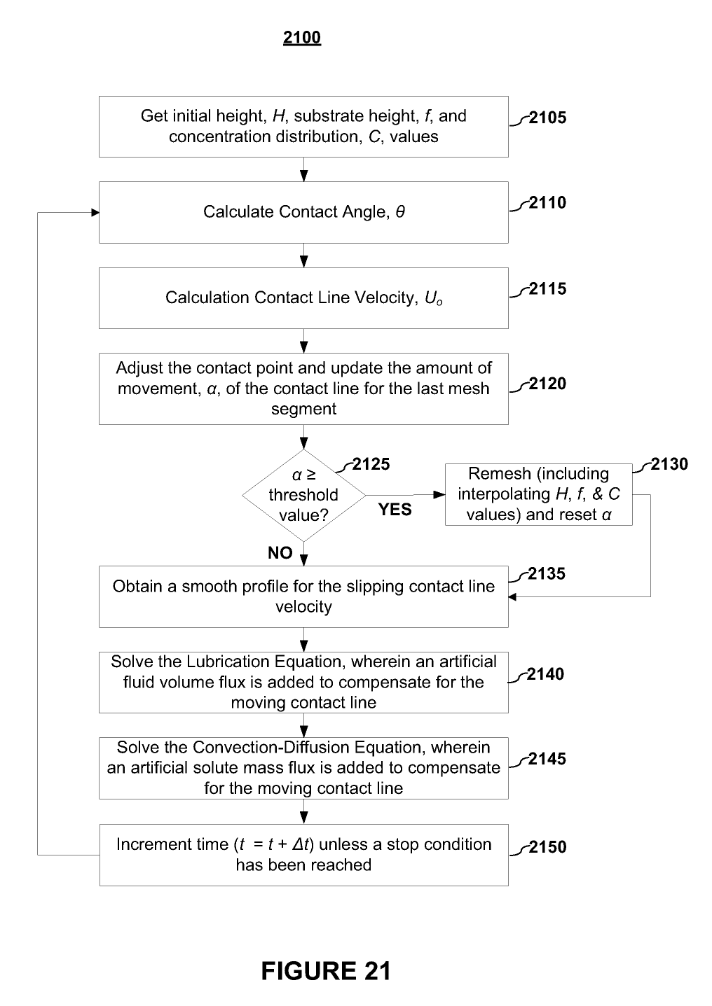

The teachings of the prior section may be used to simulate droplet height and/or the solute concentration of an evaporating droplet on a non-planar substrate according to embodiments. By way of illustration and not limitation, FIG. 21 depicts methods for simulating the solute concentration of evaporating droplet on a non-planar surface according to embodiments of the present invention. As depicted in FIG. 21, the initial height values, H, of droplet and the substrate, f, and the initial concentration distribution, C, are calculated or set (2105). One skilled in the art shall recognize that the height profile/values, the concentration distribution/values, and/or the substrate profile/values may be obtained from experimental data.

The contact angle, θ, is calculated (2110). One skilled in the art shall recognize that the contact angle, θ, may be calculated using geometry or also obtained from experimental data.

Given the contact angle, θ, the contact line velocity, Uₒ, of the slipping contact line is calculated (2115). In embodiments, as previously noted, the contact line velocity may be determined using Hoffman's model, although other methods may be employed.

The contact point for the droplet is adjusted (2120) based upon the slipping velocity and the time step. The amount that the contact line has slipped or moved, α, in the last mesh element is also updated (2120). It shall be noted that if the contact line velocity, Uₒ, is zero, there will be no adjustment to the contact point or to the decimal percent amount of movement, α.

At step 2125, the amount of movement, α, is checked to determine if it is greater than or equal to a threshold amount. If it is greater than or equal to a threshold amount, the domain is remeshed (2130). In embodiments, α may be set to 0.25, but other values may be selected. One skilled in the art shall recognize that the condition can be set at just greater than (rather than greater than or equal to) a threshold by adjusting the threshold level. In embodiments, remeshing involves re-discretizing the domain into cells or elements and interpolating the height values (H and f) and solute concentration values (C) of the droplet at the remeshed cell centers. In embodiments, the cells may be remeshed into uniform cells, although other configurations may be used. When the domain is remeshed, the contact line of the droplet will be at the end of the domain; therefore, the amount of movement, α, is set (2130) to zero to reflect this change.

If the amount of movement, α, is not greater than or equal to a threshold amount, a smooth profile is obtain (2135) for the slipping contact line. The lubrication equation is solved (2140), wherein an artificial fluid flux is added to compensate for the moving contact line.

Having solved the lubrication equation to obtain Hⁿ⁺¹ at tⁿ⁺¹=tⁿ+Δt, where Δt is the time step, that solution is used in solving (2145) the convection/diffusion equation. Similar to the lubrication equation, when the contact line is adjusted at step 2120, a portion of the droplet volume is lost. To compensate for the lost solute, a solute mass flux is added when solving the convection/diffusion equation.

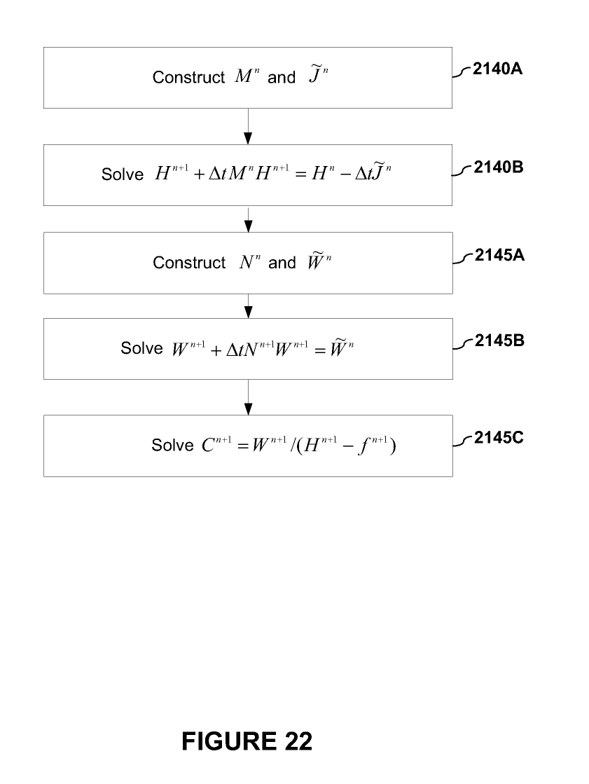

FIG. 22 depicts a method for obtaining the height and solute concentration values according to embodiments of the present invention. As previously explained above, the lubrication equation can be solved by constructing Mⁿ and \tilde{J}ⁿ (2140A) and solving (2140B) the following:

Hⁿ⁺¹+ΔtMⁿHⁿ⁺¹=Hⁿ−Δt\tilde{J}ⁿ

As depicted in FIG. 22, at step 2145A, the matrices Nⁿ and \tilde{W}ⁿ are constructed. and used in solving (2145B) the following:

Wⁿ⁺¹+ΔtNⁿ⁺¹Wⁿ⁺¹=\tilde{W}ⁿ

Given Hⁿ⁺¹ and Wⁿ⁺¹, the solute concentration Cⁿ⁺¹ can be calculated (2145C) from Wⁿ⁺¹/(Hⁿ⁺¹−fⁿ⁺¹).

Unless a stop condition has been reached (2150), the time step is incremented (2150) and the process iterates by returning to step 2110. In embodiments, the stop conditions may be one or more of the stop condition previously mentioned.

### E. Numerical Example

Presented below is an example of a droplet simulation according to embodiments of the present invention. In the following numerical example, we consider an axisymmetric droplet with initial height hₒ=18.725 (μm), initial width Rₒ=63.496 (μm), surface tension coefficient σ=0.0365 (N/m), and initial evaporation rate Jₒ=2.0e−11 (m/s). The time step used in the simulation was Δt=0.005852 (sec).

It is assumed that the liquid becomes a gel when the solute concentration C reaches a certain value C_{g} called the gelation concentration. Therefore, the viscosity of the fluid was modeled as μ=μₒ(1+η) where

$$η = \frac{1}{1 - {( \frac{C}{{C}_{g}} )}^{n}} - 1$$

and n=100 reflecting the rapid change in the viscosity as C approaches C_{g}, and μₒ is initial viscosity μₒ=0.00485 (Pa sec). The evaporation was modeled by

$$J = {J}_{o} ( 1 - \frac{C}{{C}_{g}} )$$

so that the evaporation slows to stop as the liquid solidifies. The diffusion coefficient D was also dependent on the viscosity as written in D=1/(μₒ(1+η)).

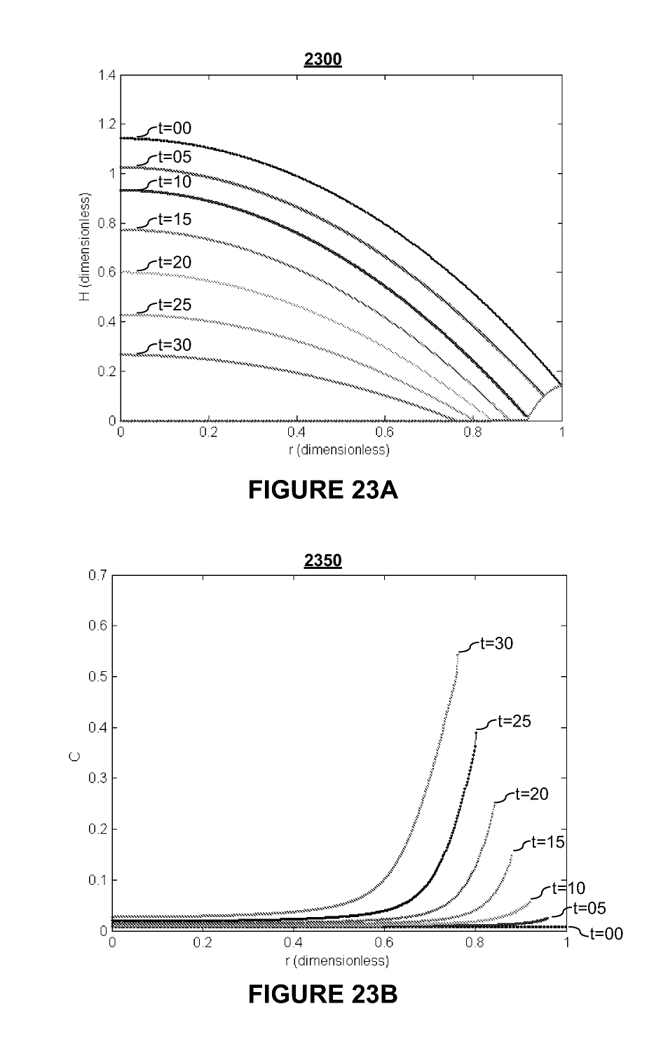

The case of constant slipping velocity, Uₒ=0.4069 μm/s was considered. Both lubrication and solute equations were solved for 30 seconds, and the change in the droplet height and solute concentration in dimensionless form are plotted in the FIG. 23A and FIG. 23B, respectively. During this time period, a total of 419 remeshings were performed. The solute mass at t=0 was 0.002548183, and the solute mass at t=30 sec was 0.002534280, which is well conserved. To check the droplet mass conservation, numerically calculated droplet mass was 0.279876558, while the total mass evaporation was obtained as 0.279686625, which was also well conserved.

### IV. System

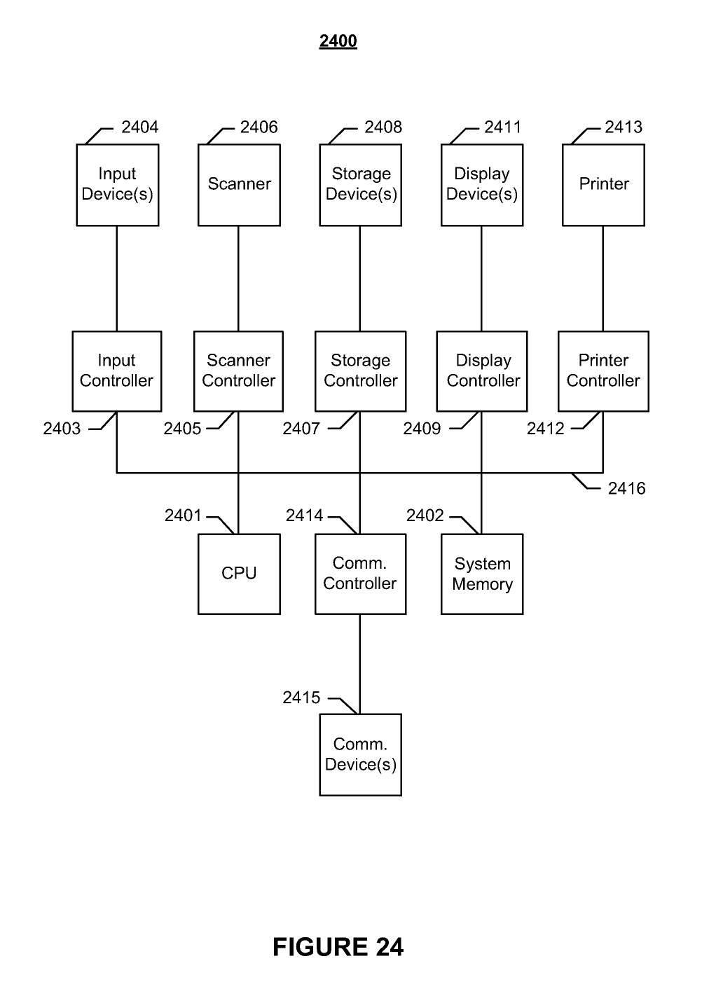

Having described the details of the invention, an exemplary system 2400, which may be used to implement one or more aspects of the present invention, will now be described with reference to FIG. 24. As illustrated in FIG. 24, the system includes a central processing unit (CPU) 2401 that provides computing resources and controls the computer. The CPU 2401 may be implemented with a microprocessor or the like, and may also include a graphics processor and/or a floating point coprocessor for mathematical computations. The system 2400 may also include system memory 2402, which may be in the form of random-access memory (RAM) and read-only memory (ROM).

A number of controllers and peripheral devices may also be provided, as shown in FIG. 24. An input controller 2403 represents an interface to various input device(s) 2404, such as a keyboard, mouse, or stylus. There may also be a scanner controller 2405, which communicates with a scanner 2406. The system 2400 may also include a storage controller 2407 for interfacing with one or more storage devices 2408 each of which includes a storage medium such as magnetic tape or disk, or an optical medium that might be used to record programs of instructions for operating systems, utilities and applications which may include embodiments of programs that implement various aspects of the present invention. Storage device(s) 2408 may also be used to store processed data or data to be processed in accordance with the invention. The system 2400 may also include a display controller 2409 for providing an interface to a display device 2411, which may be a cathode ray tube (CRT), or a thin film transistor (TFT) display. The system 2400 may also include a printer controller 2412 for communicating with a printer 2413. A communications controller 2414 may interface with one or more communication devices 2415 which enables the system 2400 to connect to remote devices through any of a variety of networks including the Internet, a local area network (LAN), a wide area network (WAN), or through any suitable electromagnetic carrier signals including infrared signals.

In the illustrated system, all major system components may connect to a bus 2416, which may represent more than one physical bus. However, various system components may or may not be in physical proximity to one another. For example, input data and/or output data may be remotely transmitted from one physical location to another. In addition, programs that implement various aspects of this invention may be accessed from a remote location (e.g., a server) over a network. Such data and/or programs may be conveyed through any of a variety of machine-readable medium including magnetic tape or disk or optical disc, or a transmitter, receiver pair.

The present invention may be conveniently implemented with software. However, alternative implementations are certainly possible, including a hardware implementation or a software/hardware implementation. Any hardware-implemented functions may be realized using ASIC(s), digital signal processing circuitry, or the like. With these implementation alternatives in mind, it is to be understood that the figures and accompanying description provide the functional information one skilled in the art would require to write program code (i.e., software) or to fabricate circuits (i.e., hardware) to perform the processing required.

In accordance with further aspects of the invention, any of the above-described methods or steps thereof may be embodied in a program of instructions (e.g., software), which may be stored on, or conveyed to, a computer or other processor-controlled device for execution on a computer-readable medium. Alternatively, any of the methods or steps thereof may be implemented using functionally equivalent hardware (e.g., application specific integrated circuit (ASIC), digital signal processing circuitry, etc.) or a combination of software and hardware. In embodiments, one or more of the methods may be implemented using one or more processing units/systems.

While the invention has been described in conjunction with several specific embodiments, it is evident to those skilled in the art that many further alternatives, modifications, and variations will be apparent in light of the foregoing description. Thus, the invention described herein is intended to embrace all such alternatives, modifications, applications and variations as may fall within the spirit and scope of the appended claims.

What is claimed is:

1. A computer-implemented method for simulating droplet height changes due to evaporation, the method comprising:
[a] generating a mesh for a domain of at least a portion of a droplet with a contact edge on a surface, the mesh comprising a plurality of cells and the plurality of cells comprising an end cell with an outer edge correlated with the contact edge of the droplet;
[b] determining a contact edge velocity of the contact edge of the droplet;
[c] adjusting, based on the contact edge velocity, the contact edge of the droplet;
[d] obtaining a smooth profile for the contact edge velocity; and
[e] solving a lubrication equation to obtain droplet height values, the lubrication equation including an artificial fluid flux to compensate for loss due to the adjusting of the contact edge of the droplet in step [c].

2. The computer-implemented method of claim 1 wherein the surface is non-planar.

3. The computer-implemented method of claim 2 further comprising:
incrementing a time variable; and
iterating steps [b] and through [e] until a stop condition is reached.

4. The computer-implemented method of claim 3 further comprising:
responsive to the end cell of the mesh being adjusted at step [c] to a size at or below a threshold value, remeshing the domain of the at least a portion of the droplet with the contact edge.

5. The computer-implemented method of claim 4 wherein the step of remeshing comprises:
generating a new mesh for the domain of the at least a portion of the droplet with the contact edge, the new mesh comprising a plurality of cells and the plurality of cells comprising an end cell with an outer edge correlated with the contact edge of the droplet; and
interpolating droplet height values for the new mesh.

6. The computer-implemented method of 5 wherein the plurality of cells of the mesh and the new mesh are initially uniform in size.

7. The computer-implemented method of 1 further comprising:
[f] solving a convection-diffusion equation to obtain solute concentration values in the droplet, the convection-diffusion equation including an artificial solute flux to compensate for the adjusting of the contact edge of the droplet and the convection-diffusion equation using height values obtained from solving the lubrication equation in step [e].

8. The computer-implemented method of claim 7 further comprising:
incrementing a time variable; and
iterating steps [b] through [f] until a stop condition is reached.

9. A computer program product comprising at least one non-transitory computer-readable medium storing one or more sequences of instructions, wherein execution of the one or more sequences of instructions by one or more processors causes the one or more processors to perform the method of claim 1.

10. A computer program product comprising at least one non-transitory computer-readable medium storing one or more sequences of instructions, wherein execution of the one or more sequences of instructions by one or more processors causes the one or more processors to simulate evaporation of a droplet by performing the steps comprising:
generating a discretized model of at least a portion of a droplet with a contact line on a surface; and
iterating steps listed below until a stop condition is reached:
moving the contact line based upon a contact line velocity multiplied by a time increment;
responsive to the contact line having moved more than a threshold amount, generating an updated discretized model of the at least a portion of a droplet with the contact line;
solving a lubrication equation to obtain droplet height information for the at least a portion of a droplet, wherein responsive to the contact line having moved, adding an artificial fluid flux when solving the lubrication equation to account for fluid loss due to the contact line moving; and
incrementing a time value by the time increment.

11. The computer program product of claim 10 wherein the surface is non-planar.

12. The computer program product of claim 11 further comprising:
solving a convection-diffusion equation for the at least a portion of a droplet, wherein responsive to the contact line having moved, adding an artificial solute flux when solving the convection-diffusion equation to account for solute loss due to the contact line moving, the convection-diffusion equation using as input height information obtained from solving the lubrication equation.

13. The computer program product of claim 12 wherein the step of generating an updated discretized model of the at least a portion of a droplet with the contact line comprises:
generating a mesh comprising a plurality of elements for a domain of the at least a portion of the droplet with the contact line; and
interpolating height and concentration values for the mesh.

14. The computer program product of 10 further comprising:
determining the contact line velocity of the contact line of the droplet.

15. The computer program product of 14 wherein the step of determining a contact line velocity of the contact line of the droplet comprises:
determining an angle between the contact line of the droplet and the non-planar surface; and
using the angle and Hoffman's model to determine the contact line velocity.

16. A computer-implemented method using at least one processing unit to simulate droplet evaporation of a droplet with a moving contact line, the method comprising:
performing calculations using the at least one central processing unit to calculate movement of the moving contact line of the droplet;
performing calculations using the at least one processing unit to solve a lubrication equation for modeling evaporation of the droplet with the moving contact line on a surface, the calculations being performed to simulate a height profile of at least a portion of the droplet and adding a fluid flux when solving the lubrication equation to account for fluid loss due to movement of the moving contact line; and
performing calculations using at least some of the height profile of the droplet to solve a convection-diffusion equation, the calculations being performed to simulate solute concentration of the at least a portion of the droplet and adding a solute flux to the droplet when solving the solute convection-diffusion equation to account for solute mass change due to movement of the moving contact line.

17. The computer-implemented method of claim 16 wherein the surface is non-flat.

18. The computer-implemented method of claim 17 further comprising:
moving the moving contact line based upon a contact line velocity multiplied by a time increment; and
responsive to the contact line having moved more than a threshold amount, generating an updated discretized model of at least a portion of the droplet.

19. The computer-implemented method of claim 18 wherein the step of generating an updated discretized model of at least a portion of the droplet comprises:
generating a mesh for a domain of the at least a portion of the droplet with the moving contact line, the mess comprising a plurality of cells that are initially uniform in size; and
interpolating height and concentration values for the mesh.

20. The computer program product of 18 further comprising:
determining the contact line velocity of the contact line of the droplet.

21. The computer program product of 20 wherein the step of determining a contact line velocity of the contact line of the droplet comprises:
determining an angle between the contact line of the droplet and the non-flat surface; and
using the angle and Hoffman's model to determine the contact edge velocity.

22. A computer program product comprising at least one non-transitory computer-readable medium storing one or more sequences of instructions, wherein execution of the one or more sequences of instructions by one or more processors causes the one or more processors to perform the method of claim 16.
